(19) United States
(12) Patent Application Publication
(10) Pub. No.: US 2026/0197815 A1
(43) Pub. Date: Jul. 9, 2026

(54) SCHEDULING OF EXTENDED REALITY PERCEPTION-TYPE TRAFFIC

(71) Applicant: QUALCOMM Incorporated, San Diego, CA (US)

(72) Inventors: Hussein METWALY SAAD, Poway, CA (US); Diana MAAMARI, San Diego, CA (US); Peerapol TINNAKORNSRISUPHAP, San Diego, CA (US); Simone MERLIN, San Diego, CA (US); Hyun Yong LEE, San Diego, CA (US); Mickael MONDET, Louannec (FR); Belal Salama Amin KORANY, San Diego, CA (US)

(21) Appl. No.: 19/013,798

(22) Filed: Jan. 8, 2025

(51) Int. Cl. H04W 72/12; H04W 72/21; H04W 76/28

(52) U.S. Cl. CPC H04W 72/12; H04W 72/21; H04W 76/28

(57) ABSTRACT

Methods, systems, and devices for wireless communications are described, including for extended reality (XR) communications. XR devices may implement perception algorithms, which may include depth map generation, image segmentation, 3D reconstruction, and/or object tracking. Perception algorithms may involve complex and power-intensive operations, and thus may be offloaded from a user equipment (UE) to a remote device such as a server. The network entity may configure a discontinuous reception (DRX) pattern for the UE during which the UE cycles between monitoring for downlink transmissions and not monitoring for downlink transmissions. The network entity may obtain XR perception-type traffic information that indicates the uplink periodicity and the uplink to downlink offset for XR perception-type traffic. The network entity may schedule uplink or downlink transmissions for the UE based on the obtained information. The network entity may configure a DRX pattern for the UE based on the XR perception-type traffic information.

### FIELD OF TECHNOLOGY

The following relates to wireless communications, including scheduling of extended reality perception-type traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include obtaining a message that is indicative of an uplink periodicity for extended reality (XR) perception-type traffic associated with a user equipment (UE) and that is indicative of an uplink-to-downlink offset for the XR perception-type traffic and outputting, for the UE and based on the message, scheduling information for one or more downlink or uplink transmissions associated with the XR perception-type traffic.

A network entity for wireless communications is described. The network entity may include one or more memories storing processor executable code, and one or more processors coupled with the one or more memories. The one or more processors may individually or collectively be operable to execute the code to cause the network entity to obtain a message that is indicative of an uplink periodicity for XR perception-type traffic associated with a UE and that is indicative of an uplink-to-downlink offset for the XR perception-type traffic and output, for the UE and based on the message, scheduling information for one or more downlink or uplink transmissions associated with the XR perception-type traffic.

Another network entity for wireless communications is described. The network entity may include means for obtaining a message that is indicative of an uplink periodicity for XR perception-type traffic associated with a UE and that is indicative of an uplink-to-downlink offset for the XR perception-type traffic and means for outputting, for the UE and based on the message, scheduling information for one or more downlink or uplink transmissions associated with the XR perception-type traffic.

A non-transitory computer-readable medium storing code for wireless communications is described. The code may include instructions executable by one or more processors to obtain a message that is indicative of an uplink periodicity for XR perception-type traffic associated with a UE and that is indicative of an uplink-to-downlink offset for the XR perception-type traffic and output, for the UE and based on the message, scheduling information for one or more downlink or uplink transmissions associated with the XR perception-type traffic.

In some examples of the method, network entities, and non-transitory computer-readable medium described herein, obtaining the message may include operations, features, means, or instructions for obtaining a time sensitive assistance information message via an application function associated with an XR application.

In some examples of the method, network entities, and non-transitory computer-readable medium described herein, obtaining the message may include operations, features, means, or instructions for obtaining the message including a data packet and a header, where the header may be indicative of the uplink periodicity and the uplink-to-downlink offset, where the data packet includes data associated with the XR perception-type traffic.

In some examples of the method, network entities, and non-transitory computer-readable medium described herein, obtaining the message may include operations, features, means, or instructions for obtaining the message via an application function associated with an XR application, where the header includes a real time transfer protocol header extension.

In some examples of the method, network entities, and non-transitory computer-readable medium described herein, obtaining the message may include operations, features, means, or instructions for obtaining the message via a user plane function, where the header includes a general packet radio service tunnelling protocol header.

In some examples of the method, network entities, and non-transitory computer-readable medium described herein, obtaining the message may include operations, features, means, or instructions for obtaining the message via the UE, where the header includes a Service Data Adaption Protocol header or a packet data convergence protocol header, and where the data packet includes data associated with the XR perception-type traffic.

Some examples of the method, network entities, and non-transitory computer-readable medium described herein may further include operations, features, means, or instructions for obtaining a second message including a second data packet, where the second data packet includes data associated with the XR perception-type traffic, and where an indication of the uplink periodicity and the uplink-to-downlink offset may be absent from the second message.

Some examples of the method, network entities, and non-transitory computer-readable medium described herein may further include operations, features, means, or instructions for outputting a request for an indication of the uplink periodicity and the uplink-to-downlink offset, where the message may be based on the request.

In some examples of the method, network entities, and non-transitory computer-readable medium described herein, the message may be one of a radio resource control (RRC) message, a medium access control (MAC) control element (MAC-CE), or an uplink control information (UCI) message.

Some examples of the method, network entities, and non-transitory computer-readable medium described herein may further include operations, features, means, or instructions for outputting, where the message obtained via the UE and may be a first message, a second message for the UE that indicates a threshold to trigger reporting of the uplink-to-downlink offset, where the first message indicates that the uplink-to-downlink offset may be different from a previous value of the uplink-to-downlink offset by at least the threshold.

In some examples of the method, network entities, and non-transitory computer-readable medium described herein, the message may be indicative of the uplink-to-downlink offset via inclusion of an indication of a delta value and the delta value may be with respect to a previous uplink-to-downlink offset.

In some examples of the method, network entities, and non-transitory computer-readable medium described herein, the indication of the delta value includes an index value from a table of delta values, the index value corresponding to the delta value.

In some examples of the method, network entities, and non-transitory computer-readable medium described herein, outputting the scheduling information may include operations, features, means, or instructions for outputting control signaling that configures a discontinuous reception configuration for the UE.

In some examples of the method, network entities, and non-transitory computer-readable medium described herein, the message may be indicative of the uplink-to-downlink offset via inclusion of an indication of a lower bound for the uplink-to-downlink offset and an upper bound for the uplink-to-downlink offset.

In some examples of the method, network entities, and non-transitory computer-readable medium described herein, the message may be indicative of the uplink-to-downlink offset via inclusion of at least one of a range for the uplink-to-downlink offset, a mean for the uplink-to-downlink offset, or a standard deviation for the uplink-to-downlink offset.

Some examples of the method, network entities, and non-transitory computer-readable medium described herein may further include operations, features, means, or instructions for obtaining, in association with the UE and in accordance with the uplink periodicity, an uplink transmission associated with the XR perception-type traffic and outputting, for the UE and in accordance with the scheduling information, a downlink transmission of the one or more downlink or uplink transmissions that may be responsive to the uplink transmission.

Some examples of the method, network entities, and non-transitory computer-readable medium described herein may further include operations, features, means, or instructions for outputting, to a target network entity for a handover procedure associated with the UE, a second message that indicates the XR perception-type traffic and the uplink-to-downlink offset for the XR perception-type traffic.

Some examples of the method, network entities, and non-transitory computer-readable medium described herein may further include operations, features, means, or instructions for obtaining, via the message or a second message, an indication of a second uplink periodicity for a second type of XR perception-type traffic associated with the UE and an indication of a second uplink-to-downlink offset for the second type of XR perception-type traffic, where the XR perception-type traffic may be a first type of XR perception-type traffic and outputting for the UE and based on the indication of the second uplink periodicity and the indication of the second uplink-to-downlink offset, second scheduling information for one or more second downlink or uplink transmissions associated with the second type of XR perception-type traffic.

A method for wireless communications by a UE is described. The method may include transmitting a message that is indicative of an uplink periodicity for XR perception-type traffic associated with the UE and that is indicative of an uplink-to-downlink offset for the XR perception-type traffic and receiving, based on the message, scheduling information for one or more downlink or uplink transmissions associated with the XR perception-type traffic.

A UE for wireless communications is described. The UE may include one or more memories storing processor executable code, and one or more processors coupled with the one or more memories. The one or more processors may individually or collectively be operable to execute the code to cause the UE to transmit a message that is indicative of an uplink periodicity for XR perception-type traffic associated with the UE and that is indicative of an uplink-to-downlink offset for the XR perception-type traffic and receive, based on the message, scheduling information for one or more downlink or uplink transmissions associated with the XR perception-type traffic.

Another UE for wireless communications is described. The UE may include means for transmitting a message that is indicative of an uplink periodicity for XR perception-type traffic associated with the UE and that is indicative of an uplink-to-downlink offset for the XR perception-type traffic and means for receiving, based on the message, scheduling information for one or more downlink or uplink transmissions associated with the XR perception-type traffic.

A non-transitory computer-readable medium storing code for wireless communications is described. The code may include instructions executable by one or more processors to transmit a message that is indicative of an uplink periodicity for XR perception-type traffic associated with the UE and that is indicative of an uplink-to-downlink offset for the XR perception-type traffic and receive, based on the message, scheduling information for one or more downlink or uplink transmissions associated with the XR perception-type traffic.

In some examples of the method, UEs, and non-transitory computer-readable medium described herein, the message may be one of an RRC message, a MAC-CE, or a UCI message.

In some examples of the method, UEs, and non-transitory computer-readable medium described herein, transmitting the message may include operations, features, means, or instructions for transmitting the message including a data packet and a header, where the header may be indicative of the uplink periodicity and the uplink-to-downlink offset, where the data packet includes data associated with the XR perception-type traffic.

In some examples of the method, UEs, and non-transitory computer-readable medium described herein, the header includes a Service Data Adaption Protocol header or a packet data convergence protocol header and the data packet includes data associated with the XR perception-type traffic.

Some examples of the method, UEs, and non-transitory computer-readable medium described herein may further include operations, features, means, or instructions for transmitting a second message including a second data packet, where the second data packet includes data associated with the XR perception-type traffic, and where an indication of the uplink periodicity and the uplink-to-downlink offset may be absent from the second message.

Some examples of the method, UEs, and non-transitory computer-readable medium described herein may further include operations, features, means, or instructions for receiving a request for an indication of the uplink periodicity and the uplink-to-downlink offset, where transmitting the message may be based on the request.

In some examples of the method, UEs, and non-transitory computer-readable medium described herein, the message may be indicative of the uplink-to-downlink offset via inclusion of an indication of a delta value and the delta value may be with respect to a previous uplink-to-downlink offset.

In some examples of the method, UEs, and non-transitory computer-readable medium described herein, the indication of the delta value includes an index value from a table of delta values, the index value corresponding to the delta value.

Some examples of the method, UEs, and non-transitory computer-readable medium described herein may further include operations, features, means, or instructions for receiving, where the message may be a first message, a second message that indicates a threshold to trigger reporting of the uplink-to-downlink offset, where the first message indicates that the uplink-to-downlink offset may be different from a previous value of the uplink-to-downlink offset by at least the threshold.

In some examples of the method, UEs, and non-transitory computer-readable medium described herein, receiving the scheduling information may include operations, features, means, or instructions for control signaling that configures a discontinuous reception configuration for the UE.

In some examples of the method, UEs, and non-transitory computer-readable medium described herein, the message may be indicative of the uplink-to-downlink offset via inclusion of an indication of a lower bound for the uplink-to-downlink offset and an upper bound for the uplink-to-downlink offset.

In some examples of the method, UEs, and non-transitory computer-readable medium described herein, the message may be indicative of the uplink-to-downlink offset via inclusion of at least one of a range for the uplink-to-downlink offset, a mean for the uplink-to-downlink offset, or a standard deviation for the uplink-to-downlink offset.

Some examples of the method, UEs, and non-transitory computer-readable medium described herein may further include operations, features, means, or instructions for transmitting, in accordance with the uplink periodicity, an uplink transmission associated with the XR perception-type traffic and receiving, in accordance with the scheduling information, a downlink transmission of the one or more downlink or uplink transmissions that may be responsive to the uplink transmission.

Some examples of the method, UEs, and non-transitory computer-readable medium described herein may further include operations, features, means, or instructions for transmitting, via the message or a second message, an indication of a second uplink periodicity for a second type of XR perception-type traffic associated with the UE and an indication of a second uplink-to-downlink offset for the second type of XR perception-type traffic, where the XR perception-type traffic may be a first type of XR perception-type traffic and receiving, based on the indication of the second uplink periodicity and the indication of the second uplink-to-downlink offset, second scheduling information for one or more second downlink or uplink transmissions associated with the second type of XR perception-type traffic.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scheduling of extended reality (XR) perception-type traffic in accordance with one or more aspects of the present disclosure.

FIG. 2 shows an example of timing diagrams that support scheduling of XR perception-type traffic in accordance with one or more aspects of the present disclosure.

FIG. 3 shows an example of a wireless communications system that supports scheduling of XR perception-type traffic in accordance with one or more aspects of the present disclosure.

FIG. 4 shows an example of a network information flow diagram that supports scheduling of XR perception-type traffic in accordance with one or more aspects of the present disclosure.

FIG. 5 shows an example of a process flow that supports scheduling of XR perception-type traffic in accordance with one or more aspects of the present disclosure.

FIGS. 6 and 7 show block diagrams of devices that support scheduling of XR perception-type traffic in accordance with one or more aspects of the present disclosure.

FIG. 8 shows a block diagram of a communications manager that supports scheduling of XR perception-type traffic in accordance with one or more aspects of the present disclosure.

FIG. 9 shows a diagram of a system including a device that supports scheduling of XR perception-type traffic in accordance with one or more aspects of the present disclosure.

FIGS. 10 and 11 show block diagrams of devices that support scheduling of XR perception-type traffic in accordance with one or more aspects of the present disclosure.

FIG. 12 shows a block diagram of a communications manager that supports scheduling of XR perception-type traffic in accordance with one or more aspects of the present disclosure.

FIG. 13 shows a diagram of a system including a device that supports scheduling of XR perception-type traffic in accordance with one or more aspects of the present disclosure.

FIGS. 14 through 18 show flowcharts illustrating methods that support scheduling of XR perception-type traffic in accordance with one or more aspects of the present disclosure.

### DETAILED DESCRIPTION

Some wireless communications systems, such as fifth generation (5G) communications may provide high-speed, low-latency, and high-reliability wireless connections and may support extended reality (XR) devices and cloud computing services (e.g., cloud based gaming). XR data may include virtual reality (VR) data, augmented reality (AR) data, mixed reality (MR) data, and other types of data which may be associated with high reliability and low latency transmissions. XR devices may implement perception algorithms, which may include depth map generation, image segmentation, 3D reconstruction, and/or object tracking. Perception algorithms may involve complex and power-intensive operations, and thus may be offloaded from a user equipment (UE) (e.g., an XR headset) to a remote device such as a server. Data associated with such perception algorithms that is communicated between a remote device and a UE may be referred to as perception-type traffic. Offloading such perception-type computations may involve transmission of uplink data from the UE to a network entity via a wireless link. The network entity may send the uplink data to a server via a backhaul link. The server may process the uplink data and send downlink perception-type data in response to the UE via the network entity.

To save power at the UE, the network may configure a discontinuous reception (DRX) pattern for the UE during which the UE cycles between monitoring for downlink transmissions and not monitoring for downlink transmissions. The timing of downlink transmissions for perception-type data may depend on the uplink timing, and the processing time of the server to perform the perception-type computations given the data provided from the UE in an uplink transmission. The network entity may not have information regarding such timing, and accordingly may be unable to schedule a DRX pattern for the UE, which may increase power consumption at the UE.

In accordance with aspects of this disclosure, the network entity may obtain information that indicates the uplink periodicity and the uplink to downlink offset for XR perception-type traffic. Accordingly, the network entity may schedule uplink or downlink transmissions for the UE based on the obtained information. For example, the network entity may configure a DRX pattern for the UE and may perform downlink transmissions conveying the XR perception-type traffic in accordance with the DRX pattern. In some examples, the network entity may receive perception-type traffic profile information from an application function associated with a server that performs the XR perception-type computations. For example, the perception-type traffic profile information may be a time sensitive assistance information (TSCAI) message. In some examples, the network entity may obtain the perception-type traffic profile information via user plane signaling (e.g., via a header in a data message). In some examples, the UE may estimate the time for the server to perform the computations (e.g., for the downlink to uplink offset), and accordingly the network entity may obtain the information from the UE, for example, via a control message or via a header of a data message.

Aspects of the disclosure are initially described in the context of wireless communications systems. Aspects of the disclosure are further illustrated by and described with reference to timing diagrams, network information flow diagrams, process flows, apparatus diagrams, system diagrams, and flowcharts that relate to scheduling of XR perception-type traffic.

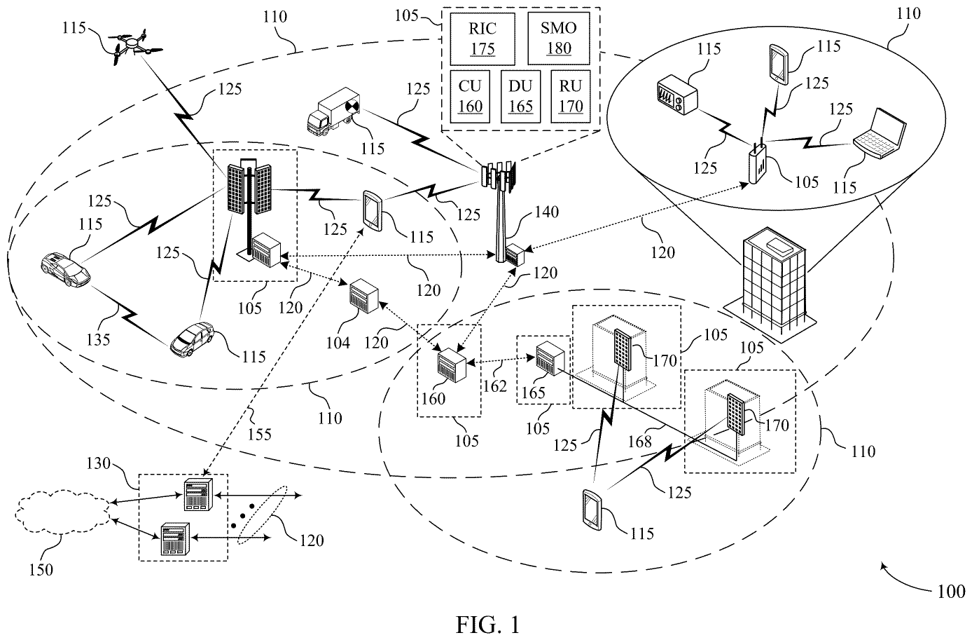

FIG. 1 shows an example of a wireless communications system 100 that supports scheduling of XR perception-type traffic in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support scheduling of XR perception-type traffic as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support XR and/or cloud computing services (e.g., cloud based gaming). XR data may include VR data, AR data, MR data, and other types of data which may be associated with high reliability and low latency transmissions. XR devices may implement perception algorithms to improve user experience. Example perception algorithms may include positional tracking, image recognition and tracking, plane detection, hand tracking, local anchors and persistence, spatial mapping and meshing, hit testing, controller tracking, and occlusion rendering. Perception algorithms may involve depth map generation (e.g., a 3-dimensional (3D) depth map) and 3D reconstruction (3DR) using the depth map. For example, in a depth map, each pixel may represent the depth of the object seen at that pixel. Depth mapping may be a key step to generate a 3D reconstruction and understanding (3DRU) of a scene. A 3DRU may refer to a physical representation of an environment, including identification of objects and surfaces. For example, input images captured by an XR device may be used to generate a depth map which may be used for 3DRU. Example use cases for 3DRU may be insertion of a virtual object on a planar surface (e.g., on a table, wall, or floor), occlusion rendering (e.g., to render a virtual object occluded by real geometry), collision warning for VR or geo-fencing for AR, specific surface segmentation (such as rendering a virtual clock on a physical wall), remote collaboration (e.g., sharing 3D geometry of physical space with remote collaborators), or remote presence (e.g., for virtual conferencing).

Perception algorithms may involve complex and power-intensive operations, and thus may be offloaded from a UE 115 (e.g., an XR headset) to a remote device such as a server. For example, battery size and thermal limits may be constraints for running perception algorithms on XR devices such as head mounted displays (HMDs) or XR glasses. Accordingly, it may not be feasible to run some perception algorithms on XR devices, such as sooty tern optimization algorithms (STOAs) on such small form-factor devices. Offloading such perception-type computations may involve transmission of uplink perception-type data from the UE 115 to a network entity 105 via a communication link 125. The network entity 105 may send the uplink perception-type data to a server via a backhaul communication link 120. The server may process the data and provide downlink perception-type data to the network entity 105 via the backhaul communication link 120, and the network entity 105 may send the downlink perception-type data to the UE 115 via the communication link 125.

Offloading computing of at least some aspects of perception algorithms from the UE 115 (e.g., the XR device) to a remote device such as the server may lead to power saving at the UE 115, may allow for smaller XR devices (e.g., smaller glasses or HMDs), and/or may lead to better user experience. For example, offloading of perception-type computations may enable the use of more complex algorithms as a server may have more computing resources that the XR devices. For example, in low light conditions, the XR device may switch to using a different depth map algorithm that runs on a server which can better compensate for the low light conditions. Attaining power savings benefits from offloading perception-type computations may depend on several factors, including modem features of the UE 115. For example, offloading perception-type computations may increase power used for transmission and reception of data with the network entity 105. Use of modem features such as DRX or physical downlink control channel (PDCCH) skipping in 5G, however, may be used to reduce the power used for transmission and reception of data with the network entity 105. For example, Table 1 shows power savings gains achieved by offloading perception-type computations to a remote server when accounting for transmission and reception of such traffic with a network entity 105. As shown, implementation of connected mode DRX (CDRX) at the UE 115 may significantly reduce power consumption, as the UE 115 may reduce power consumption by only monitoring for downlink communications during the “on” period of the CDRX pattern. Proximity to a network entity 105 may also affect the power savings as the UE 115 may reduce transmission power in near cell scenarios as compared to far cell scenarios.

TABLE 1
UE power savings by offloading perception-type computations

| | Near Cell | Far Cell |
|---|---|---|
| ALWAYS ON | 143 mW | 2 mW |
| CDRX | 373 mW | 141 mW |

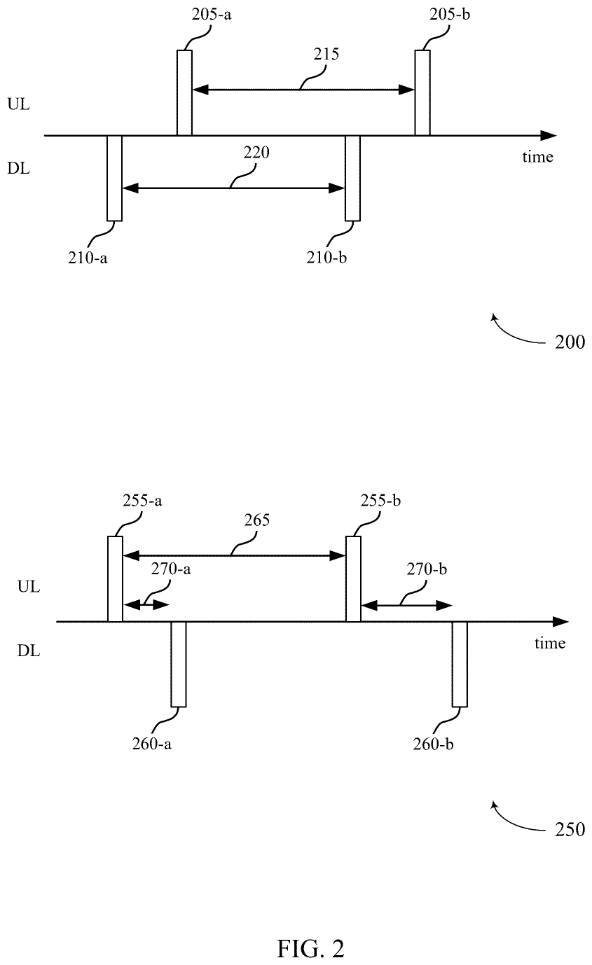

As described with reference to FIG. 2, however, the timing of downlink transmissions for perception-type data may depend on the uplink timing and the processing time of the server to perform the perception-type computations given the data provided from the UE 115 in an uplink transmission.

As described herein, in some examples, the network entity 105 may obtain information that indicates the uplink periodicity and the uplink to downlink offset for XR perception-type traffic (e.g., which may be referred to as XR perception-type traffic profile information). Accordingly, the network entity 105 may schedule uplink or downlink transmissions for the UE 115 based on the obtained XR perception-type traffic profile information. For example, the network entity may configure a DRX pattern for the UE 115 and may perform downlink transmissions that convey the XR perception-type traffic in accordance with the DRX pattern. For example, the XR perception-type traffic profile information may be obtained via a TSCAI message. In some examples, the network entity 105 may obtain the perception-type traffic profile information via user plane signaling (e.g., via a header in a data message), such as from a UPF or an application server associated with the XR-type traffic. In some examples, the UE 115 may estimate the time for the server to perform the computations (e.g., for the downlink to uplink offset), and accordingly the network entity may obtain the perception-type traffic profile information from the UE 115, for example, via a control message or via a header of a data message.

FIG. 2 shows an example of a timing diagram 200 that supports scheduling of XR perception-type traffic in accordance with one or more aspects of the present disclosure, and a timing diagram 250 that support scheduling of XR perception-type traffic in accordance with one or more aspects of the present disclosure. The timing diagram 200 and the timing diagram 250 may implement or may be implemented by aspects of the wireless communications system 100. For example, the timing diagram 200 shows an example of uplink transmissions 205 and downlink transmissions 210 for XR rendering-type data between a UE 115 and a network entity 105, and the timing diagram 250 shows an example of uplink transmissions 255 and downlink transmissions 260 for XR perception-type data between a UE 115 and a network entity 105.

Power saving features for communications, such as DRX and/or PDCCH skipping timers, may depend on the traffic profile of the communications. Accordingly, maximizing power saving of offloading computations for XR algorithms may depend on the traffic profiles of the data.

Rendering-type data for XR may refer to the data used for the process of creating and displaying three-dimensional visuals in real time as a user interacts with the environment. As shown in the timing diagram 200, rendering (e.g., at greater than or equal to 30 frames per second (FPS)) may be a periodic traffic at uplink and downlink. For example, both uplink transmissions 205 and downlink transmissions 210 may have a periodicity, which may be the same. As shown, the downlink periodicity 220 (e.g., the time between the first downlink transmission 210-a and the second downlink transmission 210-b) may be the same as the uplink periodicity 215 (e.g., the time between the first uplink transmission 205-a and the second uplink transmission 205-b). For example, both the uplink periodicity 215 and the downlink periodicity may be 16.67 ms. Accordingly, for periodic downlink traffic, the network entity 105 may design a DRX pattern that matches the downlink periodicity 220 for the UE 115 to monitor for and receive the downlink transmissions 210. Similarly, for periodic uplink traffic, the network entity 105 may schedule configured grants (CGs) that matches the uplink periodicity 215. Absent jitter in traffic arrivals, matching the CDRX and CGs to the traffic profiles for rendering type data (e.g., to the downlink periodicity 220 and the uplink periodicity) may save power without negatively affecting latency.

As shown in the timing diagram 250, perception-type traffic (e.g., for depth map creation at 5-15 FPS) may be periodic for uplink transmissions 255 but not for downlink transmissions 260. For example, uplink transmissions 255 may have a periodicity 265 (e.g., of 200 ms). For example, the periodicity 265 may correspond to the duration between the start of the uplink transmission 255-a and the start of the uplink transmission 255-b. For example, the UE 115 may load input (e.g., an image) into the uplink transmission 255, and the network entity 105 may send a corresponding downlink load (e.g., a processed image or a depth map) via a downlink transmission 260 at an offset 270 from the uplink transmission 255.

Thus, downlink traffic may be ready for transmission (e.g., as a downlink transmission 260) after an offset 270 after the corresponding uplink transmission 255. For example, the downlink transmission 260-a may be ready for transmission an offset 270-a (e.g., 50 ms) after the uplink transmission 255-a, while the downlink transmission 260-b may be ready for transmission an offset 270-b (e.g., 100 ms) after the uplink transmission 255-b. The offset 270 may be variable and may depend on the link quality (e.g., between the UE 115 and the network entity 105) and the server processing time. As the offset may be variable, designing power saving features such as a DRX pattern for the UE 115 for downlink perception-type traffic may be difficult for the network entity 105. Accordingly, as described herein, the network entity 105 may obtain information indicative of statistics for the offset 270 such that the network entity 105 may implement power saving features for the UE 115 (e.g., such that the network entity may schedule resources for uplink and/or downlink communications to save power) without impacting latency.

If the network entity 105 is provided information (e.g., from the core network 130 or the UE 115) of the perception-type traffic profile (e.g., uplink periodicity and uplink-to-downlink offset), the network entity 105 may optimize scheduling of uplink and/or downlink transmissions and may implement power saving features such as CGs and DRX for the UE 115.

For example, the offset T_{offset}=T1-T2, where T_{offset} is the offset between an uplink transmission 255 and the corresponding downlink transmission 260, T1 is the time at which the downlink load is ready for transmission, and T2 is the time at which the uplink transmission 255 is started. A server (e.g., that performs the XR perception-type processing on the uplink data and provides the corresponding downlink data) may estimate the offset as T1 is known by the server by definition and the server may estimate T2 (e.g., via signaling from the UE 115 or based on the periodicity of the uplink transmissions 255 as the uplink transmissions may be aligned with CGs). As another example, the UE 115 may estimate the offset as T2 is known at the UE 115 and the UE 115 may estimate T1 (e.g., based on the processing load).

Accordingly, as described herein, the network entity 105 may obtain signaling that indicates the perception-type traffic profile. For example, the network entity 105 may obtain the signaling from the core network via TSCAI. For example, the network entity 105 may be configured to obtain characteristics of a flow (e.g., for downlink or uplink) from the core network 130 through TSCAI. TSCAI may be modified to support indication of characteristics of the perception-type traffic (e.g., modified to indicate the uplink-to-downlink offset) in addition to characteristics of periodic flows (e.g., such as rendering).

For example, 5G communications may support TSCAI for time sensitive communications of industrial IoT. TSCAI may indicate the traffic pattern of communications to the network entity 105 (e.g., the RAN node), including the flow direction, periodicity, and/or burst arrival time. Information regarding time sensitive networking (TSN) traffic patterns may be useful to the network entity 105 for scheduling periodic, deterministic traffic flows via CGs, semi-persistent scheduling, or dynamic grants. The flow of an TSCAI message may be from the application function (AF) or network exposure function (NEF) to the policy control function (PCF) to the session management function (SMF) (e.g., which may map the timing between TSN time and 5GS time) to the AMF (e.g., the TSCAI message may be transparent to the AMF) to the network entity 105. The SMF may be responsible for mapping the burst arrival time and periodicity from an external clock (when available) to the 5G clock based on the time offset and cumulative rateRadio between the external clock time and the 5GS time as measured and reported by the UPF. For given time sensitive traffic, the AF that processes such time sensitive information to be transmitted in the time sensitive traffic may know the periodicity of the time sensitive traffic and may determine the burst arrival time. The AF may accordingly include information regarding the periodicity and burst arrival time in the TSCAI. A particular TSCAI provided to a network entity 105 may include flow direction information that indicates the direction of the time sensitive traffic (e.g., uplink or downlink), periodicity information (e.g., the time between the start of two subsequent bursts), and/or burst arrival time information (e.g., the latest possible time when the first packet of the data burst arrives at either the ingress of the RAN (for the downlink flow direction) or the egress of the UE 115 (for the uplink flow direction)).

TSCAI may include jitter characteristics and RAN feedback, which may be used by the network entity 105 to configure features such as CDRX for downlink flows. For example, Table 2 shows example information elements that may be included in a TSCAI for a time sensitive quality of service (QoS) flow in uplink or downlink. As described herein, TSCAI may be modified to support indication of characteristics of XR perception-type traffic (e.g., modified to indicate the uplink-to-downlink offset). Table 3 shows a modified TSCAI for a time sensitive QoS flow in uplink or downlink, and Table 4 shows new information elements that indicate uplink information that may be associated with the periodicity in downlink that may be included in a TSCAI. As shown in Table 4, new information elements “UL Perception Arrival Time” and “UL offset to the DL Perception Arrival Time” may be added for XR perception-type traffic. In Tables 2, 3, and 4, in the presence field, “O” may indicate an optional information element in a TSCAI and “M” may indicate a mandatory information element in a TSCAI.

TABLE 2

| | | IE type and | | Assigned |
|---|---|---|---|---|
| IE/Group Name | Presence | reference | Criticality | Criticality |
| Periodicity | M | 9.3.1.132 | — | |
| Burst Arrival | O | 9.3.1.133 | — | |
| Time | | | | |
| Survival Time | O | 9.3.1.221 | YES | ignore |
| CHOICE RAN | O | | YES | ignore |
| Feedback Type | | | | |
| >proactive | | | | |
| >>Burst Arrival | M | 9.3.1.255 | — | |
| Time Window | | | | |
| >>Periodicity | O | 9.3.1.256 | — | |
| Range | | | | |
| >reactive | | | | |
| >>Capability for | M | ENUMERATED | — | |
| BAT Adaptation | | (true, . . .) | | |
| N6 Jitter | O | 9.3.1.265 | YES | ignore |
| Information | | | | |

TABLE 3

| | | IE type and | | Assigned |
|---|---|---|---|---|
| IE/Group Name | Presence | reference | Criticality | Criticality |
| Periodicity | M | 9.3.1.132 | — | |
| Burst Arrival | O | 9.3.1.133 | — | |
| Time | | | | |
| Survival Time | O | 9.3.1.221 | YES | ignore |
| CHOICE RAN | O | | YES | ignore |
| Feedback Type | | | | |
| >proactive | | | | |
| >>Burst Arrival | M | 9.3.1.255 | — | |
| Time Window | | | | |
| >>Periodicity | O | 9.3.1.256 | — | |
| Range | | | | |
| >reactive | | | | |
| >>Capability for | M | ENUMERATED | — | |
| BAT Adaptation | | (true, . . .) | | |
| N6 Jitter | O | 9.3.1.265 | YES | ignore |
| Information | | | | |
| UL Perception | O | | | |
| Arrival Time | | | | |
| UL offset to the | O | | | |
| DL Perception | | | | |
| Arrival Time | | | | |

TABLE 4

| | | IE type and | Semantics |
|---|---|---|---|
| IE/Group Name | Presence | reference | description |
| UL to DL Offset Lower | M | INTEGER | Indicates the |
| Bound | | (−127 . . . 127) | lower bound |
| | | | offset. The |
| | | | unit is slot |
| | | | duration |
| | | | (e.g., 0.5 ms |
| | | | for FR1) |
| UL to DL Offset Upper | M | INTEGER | Indicates the |
| Bound | | (−127 . . . 127) | upper bound |
| | | | offset. The |
| | | | unit is slot |
| | | | duration |
| | | | (e.g., 0.5 ms |
| | | | for FR1) |

In some examples, the network entity 105 may obtain the signaling that indicates the perception-type traffic profile via user plane signaling (e.g., via a header in a data message), such as from a UPF or an application server associated with the XR-type traffic. For example, the XR System Architecture and Services (SA2) working group designed the 5G XR packet data unit (PDU) set based QoS handling as an extension of the QoS framework for exchange of PDU sets. A PDU set may be one or more PDUs carrying a payload of on unit of information generated at the application level (e.g., frame(s) or video slices). All PDUs of a PDU set may be transmitted within the same QoS flow. A QoS flow may either transfer unmarked PDUs or PDUs marked with PDU set information.

Parameters to establish a PDU set QoS flow sent by the SMF to the RAN (e.g., to the network entity 105) may include: PDU set error rate (PSER), PDU set delay budget (PDUSDB), and PDU set integrated handling indication (PSIHI). PSER may indicate the maximum rate for non-congestion related packet losses. PDUSDB may indicate the maximum time between reception of the first PDU and the successful delivery of the last arrived PDU of the PDU set. PSIHI may indicate whether all PDUs are demanded for the usage of the PDU set by the applicate layer. For a 5G QoS identifier (5Q1), such parameters may apply to all PDU sets in uplink and downlink. PSER, PDUSDB, and PSIHI may be optional parameters, but at least one may be sent to the network entity 105 by the SMF to enable PDU set handling. PDU set information provided by the UPF to the RAN (e.g., to the network entity 105) may include: PDU set sequence number; end PDU of the PDU set; PDU sequence number (SN) within a PDU set; PDU set size in bytes; PDU set importance, and PDU set information identification on UPF and supported N6 protocols. The PDU set importance may indicate the importance of the PDU set within a QoS flow, which may be used by the network entity for PDU set level packet discarding in the presence of congestion. The UPF may determine the PDU set information based on instructions from the SMF and header information or protocol description over N6. B6, for example, by: matching RTS/SRTP header and payload (e.g., RFC 3550/3711/6184/7798 payload formats), in which case SA4 may define new real time transfer protocol (RTP) header extension and capture, potentially, description of usage of existing RPTP headers; or by UPF implementation (e.g., PDU set detection based on traffic characteristics, IP header parameters DSCP/TOS, IP port, or IPv6 flow used to detect PDU set). Thus, PDU set information may be provided to the network entity 105 in a general packet radio service tunnelling protocol (GTP-U) header, where such information includes the PDU set sequence number, the end of the PDU set, and PDU set size in bytes, among other indicated information. Such PDU set information may also be used to indicate the perception-type traffic profile to the network entity.

In some examples, the network entity 105 may obtain the signaling that indicates the perception-type traffic profile from the UE 115 via a control message (e.g., via RRC, a MAC control element (MAC-CE), or via uplink control information (UCI)) or as a header of a data message (e.g., header information in a PDU).

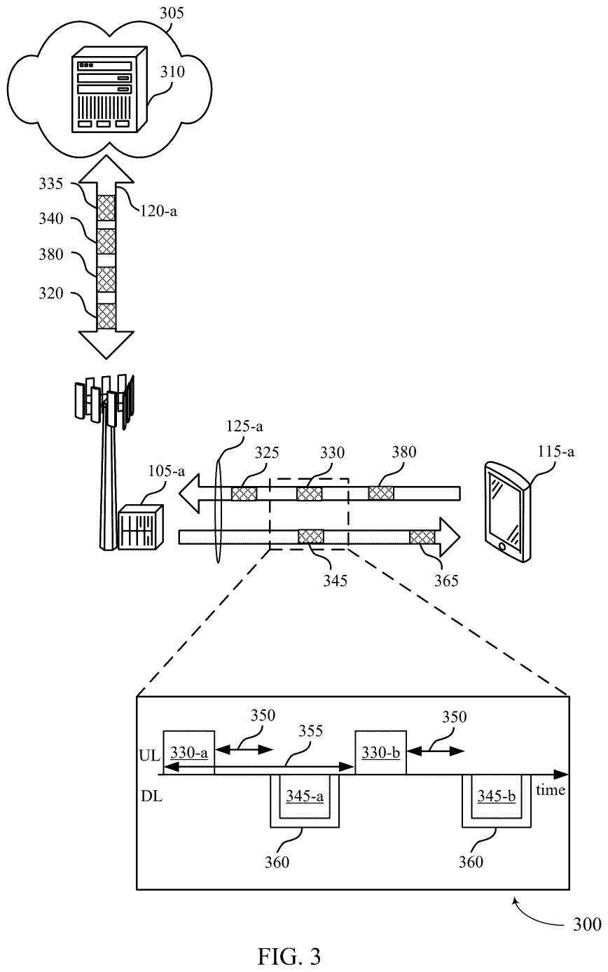

FIG. 3 shows an example of a wireless communications system 300 that supports scheduling of XR perception-type traffic in accordance with one or more aspects of the present disclosure. The wireless communications system 300 may implement or may be implemented by aspects of the wireless communications system 100. For example, the wireless communications system 300 may include a UE 115-a, which may be an example of a UE 115 as described herein. For example, the UE 115-a may be an XR device such as an XR headset. The wireless communications system 300 may include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include a bi-directional link that enables both uplink and downlink communications. For example, the UE 115-a may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-a using the communication link 125-a.

The wireless communications system 300 may include a server 310, which may be located within a cloud 305 (e.g., may be a cloud server). The network entity 105-a may communicate with the server 310 via a backhaul communication link 120-a (e.g., the network entity 105-a may communicate with the server 310 via the core network 130 and via IP services 150 as described herein).

As described herein, the UE 115-a may offload computations for XR to the server 310. For example, the UE 115-a may offload computations for perception algorithms, such as depth mapping. Such offloading may involve an uplink transmission 330 via the communication link 125-a to the network entity 105-a. The uplink transmission 330 may include data such as images captured by the UE 115-a which may be input to perception algorithms. The network entity 105-a may send the data as a communication 335 to the server 310 via the backhaul communication link 120-a. The server 310 may process the data, where processing the data involves computation of one or more perception algorithms to generate perception-type data. The server 310 may transmit the perception-type data to the network entity 105-a via the backhaul communication link 120-a as a communication 340. The network entity 105-a may transmit the perception-type data to the UE 115-a as a downlink transmission 345 via the communication link 125-a.

As described herein, in some examples, the server 310 may provide a control message 320 (e.g., a TSCAI message) to the network entity 105-a that may indicate perception-type traffic profile information for uplink transmissions 330 and downlink transmissions 345. For example, the control message 320 may indicate the uplink periodicity 355 (e.g., the duration between the start of the uplink transmission 330-a and the start of the uplink transmission 330-b) and the uplink-to-downlink offset 350 (e.g., the duration between the uplink transmission 330-a and the corresponding downlink transmission 345-a, the duration between the uplink transmission 330-b and the corresponding downlink transmission 345-b). For example, the control message 320 may include TSCAI information elements as shown in Tables 3 and 4. As described herein, such information elements may be optional fields in the TSCAI message. The uplink-to-downlink offset 350 may vary between different uplink transmissions 330 and corresponding downlink transmissions 345 (e.g., the uplink-to-downlink offset 350 between the uplink transmission 330-a and the corresponding downlink transmission 345-a may be different than the uplink-to-downlink offset 350 between the uplink transmission 330-b and the corresponding downlink transmission 345-b). Accordingly, in some examples, the uplink-to-downlink offset 350 may be indicated as an average, standard deviation, or as a range. In some examples, an offset information element in the control message 320 associated with the uplink-to-downlink offset 350 may include a lower bound (e.g., indicating the lower bound of the offset in terms of X ms) or an upper bound (e.g., indicating the lower bound of the offset in terms of X ms). In some examples, signaling 380 from the application client (e.g., at the UE 115-a) to the server 310 may trigger a TSCAI update (e.g., may trigger the server 310 to provide a control message 320 to the network entity 105-a). In some examples, the signaling 380 may be in-band signaling. In some examples, the signaling 380 may be control plane signaling (e.g., the routing of the signaling may be UE 115-a→network entity 105-a→AMF→SMF→NEF→server 310). The signaling 380 may include an indication of one or more of the perception uplink traffic periodicity (e.g., the uplink periodicity 355), the perception uplink traffic offset (e.g., the uplink-to-downlink offset 350), a range for the offset, a mean of the offset, or a standard deviation of the offset.

As described herein, in some examples, the UE 115-a may provide a control message 325 to the network entity 105-a that may indicate the perception-type traffic profile for uplink transmissions 330 and downlink transmissions 345. For example, the control message 325 may include perception-type traffic profile information obtained from the XR application client at the UE 115-a via signaling provided from the XR application client to the modem of the UE 115-a through a cross layer application programming interface (API). The UE 115-a may then provide the perception-type traffic profile information to the network entity 105-a via the control message 325. For example, the control message 325 may be a MAC-CE, an RRC message (e.g., uplink assistance information), or UCI. The perception-type traffic profile information provided by the XR application client to the modem of the UE 115-a may include an indication of one or more of the perception-type uplink traffic periodicity (e.g., the uplink periodicity 355), the perception-type uplink traffic offset (e.g., the uplink-to-downlink offset 350), a range for the offset, a mean of the offset, or a standard deviation of the offset. In some examples, the control message 325 may include the perception-type traffic profile information as provided by the XR application client to the modem of the UE 115-a. In some examples, as the uplink-to-downlink offset 350 may vary dynamically, the UE 115-a may report a delta (e.g., +/−y ms) that may be applied to the current (e.g., accumulated) value of the offset. In some examples, the possible delta values (e.g., −3, −2, −1, +1, +2, +3) may be configured or signaled by the network entity 105-a to the UE 115-a as a table, and the UE 115-a may report the index to the pre-configured table. In some examples, the control message 325 may be triggered by a network configuration. For example, the network entity 105-a may transmit control signaling that may configure a threshold (e.g., z ms), and the UE 115-a may be triggered to send a new control message 325 reporting the uplink-to-downlink offset 350 when the different between the new offset and the prior reported (e.g., the most recently reported) offset is greater than z ms.

In some examples, the perception-type traffic profile for uplink transmissions 330 and downlink transmissions 345 may be provided to the network entity 105-a in user plane signaling (e.g., in data messages). For example, a communication 340 which includes processed data from the server 310 for downlink transmission to the UE 115-a (e.g., as a downlink transmission 345) may be conveyed as a data packet with a header, and the header may include an indication of the perception-type traffic profile information. In some examples, the communication 340 may be an RTP packet provided by the server 310 (e.g., the application function or application server for the XR application at the UE 115-a) and the perception-type traffic profile information may be provided in an RTP header extension (RTP-HE). For example, the perception-type traffic profile information provided in the RTP-HE may include one or more offset values for signaling the uplink-to-downlink offset 350 between the downlink perception arrival time and the uplink traffic arrival time (e.g., the uplink-to-downlink offset) as described herein (e.g., where the downlink perception arrival time may be the latest possible time when the first packet of the perception burst arrives at the ingress of the network entity 105-a). In some examples, the RTP-HE may indicate a range for the uplink-to-downlink offset, a mean of the uplink-to-downlink offset, or a standard deviation of the uplink-to-downlink offset. In some examples, perception-type traffic profile information included in an RTP-HE may include one or more reference values indicative of associated uplink traffic arrival time (e.g., which may be the latest possible time when a first packet of an uplink data burst arrived at the interface of the UE 115-a).

In some examples, new fields in the RTP header (e.g., the RTP-HE or RTP set metadata) may be used to indicate the perception-type traffic profile information. In some examples, such fields may be mandatory. In some examples, such fields may be optional. For example, the RTP header may include perception-type traffic profile information fields when triggered by a condition such as a change in the offset or when requested by the network entity 105-a (e.g., in a request field in the communication 335).

In some examples, the communication 340 may be a GTP-U packet provided by a UPF to the network entity 105-a. In such examples, the perception-type traffic profile information may be indicated in a header of the GTP-U packet (e.g., if the UPF is able to identify the perception traffic profile). In some examples, the indication of the perception-type traffic profile information in a header of a data packet may be independent of the PDU set awareness framework described herein. For example, awareness of the PDU Set may be independent of the awareness of the perception-type traffic profile information, and the perception-type traffic profile information may be signaled separately from PDU set awareness information the GTP-U Headers.

In some examples, the UE 115-a may indicate the perception-type traffic profile information in a header of a data packet. For example, the uplink transmission 330-a may include PDUs that include a payload (e.g., XR image data for processing by the server) and a header. The header may include the perception-type traffic profile information. For example, the perception-type traffic profile information may be included in Service Data Adaptation Protocol (SDAP) headers of the PDCP headers.

In some examples, different uplink-to-downlink offset values may be determined and indicated to the network entity 105-a for different types of perception-type traffic. For example, depth map generation, segmentation, and light estimation may be associated with different uplink-to-downlink offset values which may be indicated to the network entity 105-a. Accordingly, the network entity 105-a may schedule uplink transmissions 330 and downlink transmissions associated with the different types of perception-type traffic based on the different uplink-to-downlink offset values associated with the respective types of perception-type traffic.

In some examples, in the case of a handover between a source cell and a target cell, the source cell may forward the received perception-type traffic profile information (e.g., uplink-to-downlink offset value(s) and/or uplink periodicity information) to the target cell (e.g., via the Xn-U interface). The forwarded perception-type traffic profile information may be conveyed using the GTP-U protocol (e.g., in a header of a GTP-U packet). For example, the network entity 105-a may forward such information to a target network entity 105 of a handover procedure.

As described herein, the network entity 105-a may schedule the uplink transmissions 330 and/or the downlink transmissions 345 based on the received perception-type traffic profile information. For example, based on the uplink-to-downlink offset value(s) and/or uplink periodicity information, the network entity 105-a may transmit control signaling 365 that schedules resources for the uplink transmissions 330 and/or the downlink transmissions 345. As another example, based on the uplink-to-downlink offset value(s) and/or uplink periodicity information, the network entity 105-a may transmit control signaling 365 that configures a CDRX pattern. For example, the CDRX pattern may include monitoring durations 360 during which the network entity 105-a may transmit the downlink transmissions 345. Accordingly, the UE 115-a may save power by refraining from monitoring for downlink transmissions outside of the monitoring durations 360 of the CDRX pattern.

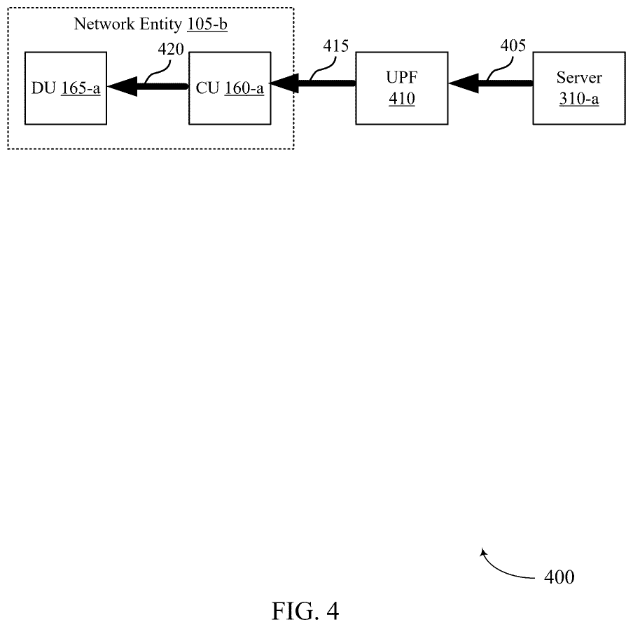

FIG. 4 shows an example of a network information flow diagram 400 that supports scheduling of XR perception-type traffic in accordance with one or more aspects of the present disclosure. The network information flow diagram 400 may implement or be implemented by the wireless communications system 100, the timing diagram 200, the timing diagram 250, and/or the wireless communications system 300. For example, the network information flow diagram 400 may include a server 310-a, which may be an example of a server 310 as described herein. The network information flow diagram 400 may include a DU 165-a and a CU 160-a of a network entity 105-b, which may be examples of corresponding devices described herein.

As described herein, a server 310-a for an XR application may determine or estimate the uplink-to-downlink offset for the perception-type traffic as T1 is known by the server 310-a (e.g., as the server 310-a transmits the downlink perception-type data when available at the server 310-a) and the server 310-a may estimate T2 (e.g., via signaling from the UE 115 or based on the periodicity of the uplink transmissions 330 as the uplink transmissions 330 may be aligned with CGs). The server 310-a may send the perception-type traffic information in an RTP-HE of an RTP packet 405.

The UPF 410 may receive the RTP packet 405 and may send the information in the RTP packet 405 to the CU 160-a via the N3 interface as a GTP-U packet 415. In some examples, the UPF 410 may include the perception-type traffic information in a header of the GTP-U packet 415. For example, the UPF 410 may decode the RTP-HE of an RTP packet 405 and may include the decoded perception-type traffic profile information in header of the GTP-U packet 415 (e.g., by extending GTP-U headers of the S1-U interface). In some examples, the RTP-HE of the RTP packet 405 may be encoded in the payload of the GTP-U packet 415 (e.g., the perception-type traffic profile information may be transparent to the UPF 410).

The DU 165-a may receive the GTP-U packet 415 and may send the information in the GTP-U packet 415 to the CU 160-a via the N3 interface as a GTP-U packet 420. In some examples, the CU 160-a may include the perception-type traffic information in a header of the GTP-U packet 420. For example, the CU 160-a may decode the header of the GTP-U packet 415 and may include the decoded perception-type traffic profile information in header of the GTP-U packet 420 (e.g., by extending GTP-U headers of the F1-U interface). In some examples, the header of the GTP-U packet 415 may be encoded in the payload of the GTP-U packet 420 (e.g., the perception-type traffic profile information may be transparent to the CU 160-a).

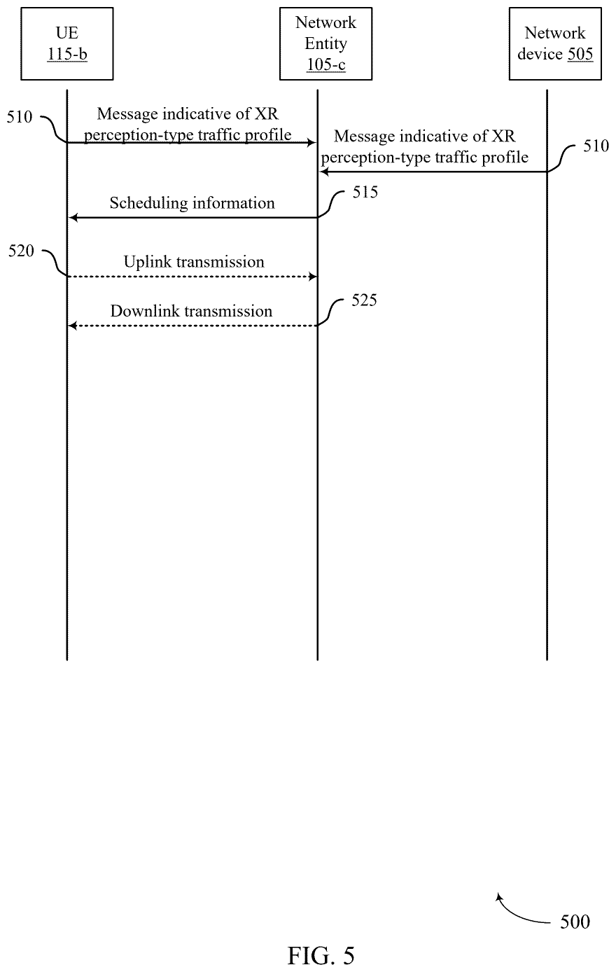

FIG. 5 shows an example of a process flow 500 that supports scheduling of XR perception-type traffic in accordance with one or more aspects of the present disclosure. The process flow 500 may implement or be implemented by the wireless communications system 100, the timing diagram 200, the timing diagram 250, the wireless communications system 300, and/or the network information flow diagram 400. For example, the process flow 500 may include a UE 115-b, a network entity 105-c, and a network device 505, which may be examples of devices described herein. For example, the network device 505 may be an application server or a UPF as described herein.

In the following description of the process flow 500, the operations between the UE 115-b, the network entity 105-c, and the network device 505 may be performed in different orders or at different times. Some operations may also be left out of the process flow 500, or other operations may be added. Although the UE 115-b, the network entity 105-c, and the network device 505 are shown performing the operations of the process flow 500, some aspects of some operations may also be performed by one or more other wireless devices.

At 510, the network entity 105-c may obtain a message that is indicative of XR perception-type traffic profile information associated with the UE 115-b. For example, the message may be indicative of an uplink periodicity for XR perception-type traffic associated with the UE and an uplink-to-downlink offset for the XR perception-type traffic.

At 515, the network entity 105-c may output, and the UE 115-b may receive, based on the message at 510, scheduling information for one or more downlink or uplink transmissions associated with the XR perception-type traffic.

In some examples, at 520, the UE 115-b may transmit, and the network entity 105-c may obtain, an uplink transmission associated with the XR perception-type traffic. In some such examples, at 525, the network entity 105-c may output, and the UE 115-b may receive, a downlink transmission of the one or more downlink or uplink transmissions that is responsive to the uplink transmission. For example, the uplink transmission may include perception-type data for processing at a server associated with an XR application which the network entity 105-c may forward to the server. The server may process the data and provide processed perception-type data for the UE 115-b. The downlink transmission at 525 may include the processed perception-type data for the UE 115-b.

In some examples, the network device 505 may be an application server or application function associated with the XR application. In some examples, the message at 510 may be a TSCAI message received from the application server or application function.

In some examples, the message at 510 may include a data packet and a header, the header may be indicative of the uplink periodicity and the uplink-to-downlink offset, and the data packet may include data associated with the XR perception-type traffic (e.g., the payload of the data packet may include the XR perception-type data). In some examples, the message at 510 may be received from the network device 505 where the network device 505 is an application server or application function associated with the XR application, and the header may be an RTP-HE (e.g., the data packet may be an RTP packet). In some examples, the message at 510 may be received from the network device 505 where the network device 505 is a UPF and the header may be a GTP-U header (e.g., the data packet may be an GTP-U packet). In some examples, the message at 510 may be received from the UE 115-b and the header may be an SDAP header or a PDCP header of a PDU that includes uplink XR perception-type traffic in a payload of the PDU. In some examples, inclusion of XR perception-type traffic profile information in a header of a data packet may be optional. For example, the network entity 105-c may obtain a second message that includes a second data packet, where the packet includes data associated with the XR perception-type traffic, and an indication of the uplink periodicity and the uplink-to-downlink offset is absent from the second message. For example, the network entity 105-c may output a request for an indication of the uplink periodicity and the uplink-to-downlink offset (e.g., to the UE 115-b or the network device 505), and the message at 510 may be based on or responsive to the request.

In some examples, the message at 510 may be a control message received from the UE 115-b (e.g., a MAC-CE, an RRC message, or a UCI).

In some examples, where the message at 510 is received from the UE 115-b, the network entity 105-c may output a second message for the UE 115-b that indicates a threshold to trigger reporting of the uplink-to-downlink offset, and the first message indicates that the uplink-to-downlink offset is different from a previous value of the uplink-to-downlink offset by at least the threshold.

In some examples, the message at 510 may be indicative of the uplink-to-downlink offset via inclusion of an indication of a delta value, and the delta value is with respect to a previous uplink-to-downlink offset.

In some examples, the network entity 105-c may output, and the UE 115-b may receive, control signaling that configures a DRX for the UE 115-b based on the uplink-to-downlink offset and/or the uplink periodicity.

In some examples, the message at 510 may be indicative of the uplink-to-downlink offset via inclusion of an indication of a lower bound for the uplink-to-downlink offset and an upper bound for the uplink-to-downlink offset. In some examples, the message at 510 may be indicative of the uplink-to-downlink offset via inclusion of at least one of a range for the uplink-to-downlink offset, a mean for the uplink-to-downlink offset, or a standard deviation for the uplink-to-downlink offset.

In some examples, the network entity 105-c may output, to a target network entity for a handover procedure associated with the UE 115-b, a second message that indicates the XR perception-type traffic and the uplink-to-downlink offset for the XR perception-type traffic.

In some examples, the network entity 105-c may obtain, via the message at 510 or a second message, an indication of a second XR perception-type traffic profile information associated for a second type of XR perception-type traffic associated with the UE 115-b. For example, the second XR perception-type traffic profile information may indicate a second uplink periodicity for the second type of XR perception-type traffic and a second uplink-to-downlink offset for the second type of XR perception-type traffic, where the XR perception-type traffic is a first type of XR perception-type traffic. In some such examples, the network entity 105-c may output, and the UE 115-b may receive, based on the indication of the second uplink periodicity and the indication of the second uplink-to-downlink offset, second scheduling information for one or more second downlink or uplink transmissions associated with the second type of XR perception-type traffic.

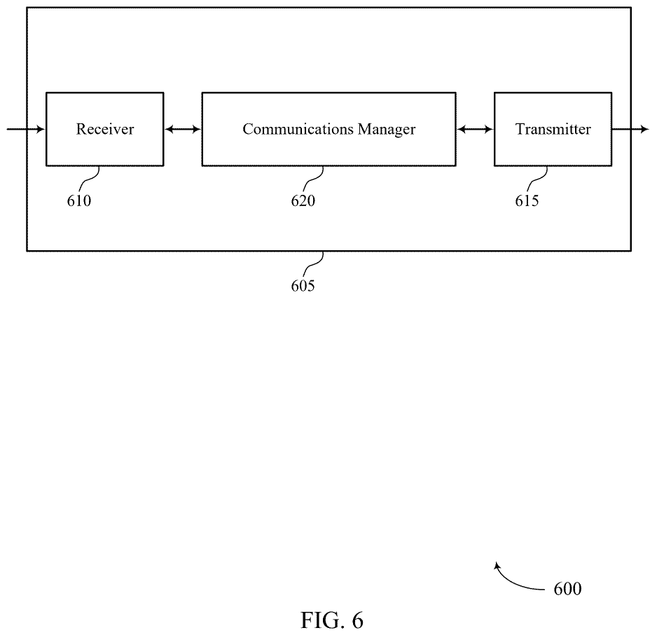

FIG. 6 shows a block diagram 600 of a device 605 that supports scheduling of XR perception-type traffic in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of scheduling of XR perception-type traffic as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for obtaining a message that is indicative of an uplink periodicity for XR perception-type traffic associated with a UE and that is indicative of an uplink-to-downlink offset for the XR perception-type traffic. The communications manager 620 is capable of, configured to, or operable to support a means for outputting, for the UE and based on the message, scheduling information for one or more downlink or uplink transmissions associated with the XR perception-type traffic.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources.

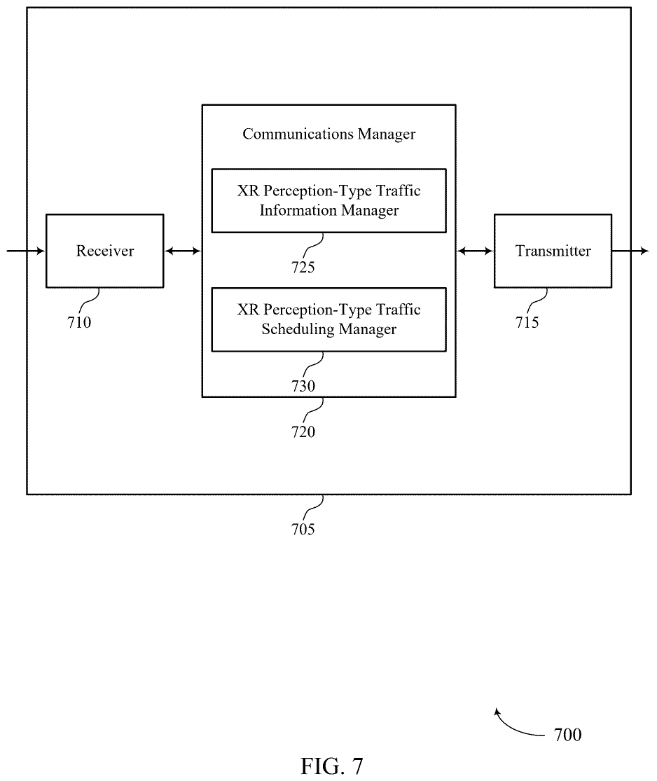

FIG. 7 shows a block diagram 700 of a device 705 that supports scheduling of XR perception-type traffic in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of scheduling of XR perception-type traffic as described herein. For example, the communications manager 720 may include an XR perception-type traffic information manager 725 an XR perception-type traffic scheduling manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The XR perception-type traffic information manager 725 is capable of, configured to, or operable to support a means for obtaining a message that is indicative of an uplink periodicity for XR perception-type traffic associated with a UE and that is indicative of an uplink-to-downlink offset for the XR perception-type traffic. The XR perception-type traffic scheduling manager 730 is capable of, configured to, or operable to support a means for outputting, for the UE and based on the message, scheduling information for one or more downlink or uplink transmissions associated with the XR perception-type traffic.

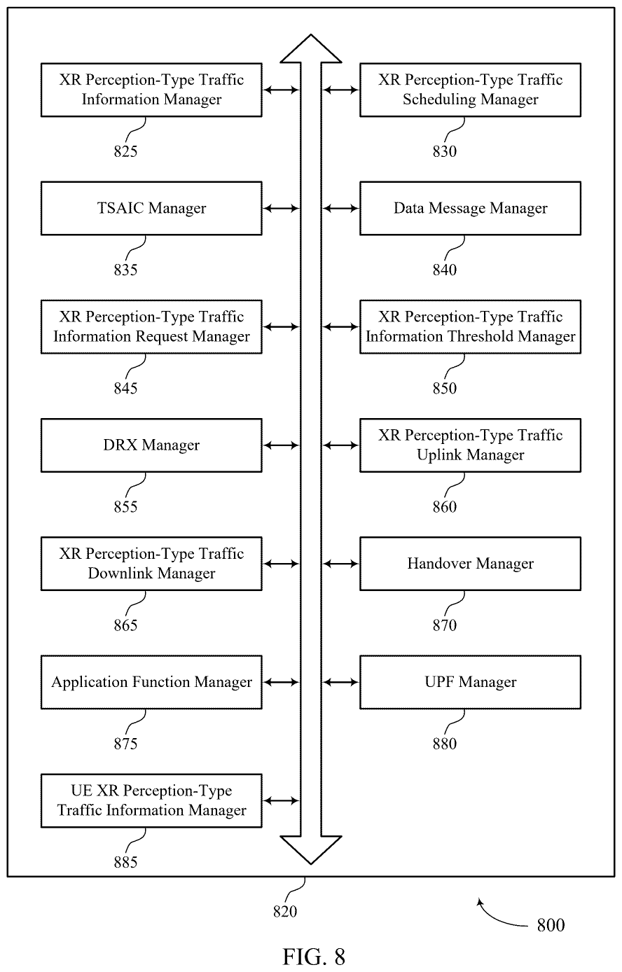

FIG. 8 shows a block diagram 800 of a communications manager 820 that supports scheduling of XR perception-type traffic in accordance with one or more aspects of the present disclosure. The communications manager 820 may be an example of aspects of a communications manager 620, a communications manager 720, or both, as described herein. The communications manager 820, or various components thereof, may be an example of means for performing various aspects of scheduling of XR perception-type traffic as described herein. For example, the communications manager 820 may include an XR perception-type traffic information manager 825, an XR perception-type traffic scheduling manager 830, a TSAIC manager 835, a data message manager 840, an XR perception-type traffic information request manager 845, an XR perception-type traffic information threshold manager 850, a DRX manager 855, an XR perception-type traffic uplink manager 860, an XR perception-type traffic downlink manager 865, a handover manager 870, an application function manager 875, a UPF manager 880, a UE XR perception-type traffic information manager 885, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The XR perception-type traffic information manager 825 is capable of, configured to, or operable to support a means for obtaining a message that is indicative of an uplink periodicity for XR perception-type traffic associated with a UE and that is indicative of an uplink-to-downlink offset for the XR perception-type traffic. The XR perception-type traffic scheduling manager 830 is capable of, configured to, or operable to support a means for outputting, for the UE and based on the message, scheduling information for one or more downlink or uplink transmissions associated with the XR perception-type traffic.

In some examples, to support obtaining the message, the TSAIC manager 835 is capable of, configured to, or operable to support a means for obtaining a TSCAI message via an application function associated with an XR application.

In some examples, to support obtaining the message, the data message manager 840 is capable of, configured to, or operable to support a means for obtaining the message including a data packet and a header, where the header is indicative of the uplink periodicity and the uplink-to-downlink offset, where the data packet includes data associated with the XR perception-type traffic.

In some examples, to support obtaining the message, the application function manager 875 is capable of, configured to, or operable to support a means for obtaining the message via an application function associated with an XR application, where the header includes a RTP-HE.

In some examples, to support obtaining the message, the UPF manager 880 is capable of, configured to, or operable to support a means for obtaining the message via a user plane function, where the header includes a GTP-U header.

In some examples, to support obtaining the message, the UE XR perception-type traffic information manager 885 is capable of, configured to, or operable to support a means for obtaining the message via the UE, where the header includes a SDAP header or a PDCP header, and where the data packet includes data associated with the XR perception-type traffic.

In some examples, the data message manager 840 is capable of, configured to, or operable to support a means for obtaining a second message including a second data packet, where the second data packet includes data associated with the XR perception-type traffic, and where an indication of the uplink periodicity and the uplink-to-downlink offset is absent from the second message.

In some examples, the XR perception-type traffic information request manager 845 is capable of, configured to, or operable to support a means for outputting a request for an indication of the uplink periodicity and the uplink-to-downlink offset, where the message is based on the request.

In some examples, the message is one of a RRC message, a MAC-CE, or an UCI message.

In some examples, the XR perception-type traffic information threshold manager 850 is capable of, configured to, or operable to support a means for outputting, where the message obtained via the UE and is a first message, a second message for the UE that indicates a threshold to trigger reporting of the uplink-to-downlink offset, where the first message indicates that the uplink-to-downlink offset is different from a previous value of the uplink-to-downlink offset by at least the threshold.

In some examples, the message is indicative of the uplink-to-downlink offset via inclusion of an indication of a delta value. In some examples, the delta value is with respect to a previous uplink-to-downlink offset.

In some examples, the indication of the delta value includes an index value from a table of delta values, the index value corresponding to the delta value.

In some examples, to support outputting the scheduling information, the DRX manager 855 is capable of, configured to, or operable to support a means for outputting control signaling that configures a DRX for the UE.

In some examples, the message is indicative of the uplink-to-downlink offset via inclusion of an indication of a lower bound for the uplink-to-downlink offset and an upper bound for the uplink-to-downlink offset.

In some examples, the message is indicative of the uplink-to-downlink offset via inclusion of at least one of a range for the uplink-to-downlink offset, a mean for the uplink-to-downlink offset, or a standard deviation for the uplink-to-downlink offset.

In some examples, the XR perception-type traffic uplink manager 860 is capable of, configured to, or operable to support a means for obtaining, in association with the UE and in accordance with the uplink periodicity, an uplink transmission associated with the XR perception-type traffic. In some examples, the XR perception-type traffic downlink manager 865 is capable of, configured to, or operable to support a means for outputting, for the UE and in accordance with the scheduling information, a downlink transmission of the one or more downlink or uplink transmissions that is responsive to the uplink transmission.

In some examples, the handover manager 870 is capable of, configured to, or operable to support a means for outputting, to a target network entity for a handover procedure associated with the UE, a second message that indicates the XR perception-type traffic and the uplink-to-downlink offset for the XR perception-type traffic.

In some examples, the XR perception-type traffic information manager 825 is capable of, configured to, or operable to support a means for obtaining, via the message or a second message, an indication of a second uplink periodicity for a second type of XR perception-type traffic associated with the UE and an indication of a second uplink-to-downlink offset for the second type of XR perception-type traffic, where the XR perception-type traffic is a first type of XR perception-type traffic. In some examples, the XR perception-type traffic scheduling manager 830 is capable of, configured to, or operable to support a means for outputting for the UE and based on the indication of the second uplink periodicity and the indication of the second uplink-to-downlink offset, second scheduling information for one or more second downlink or uplink transmissions associated with the second type of XR perception-type traffic.

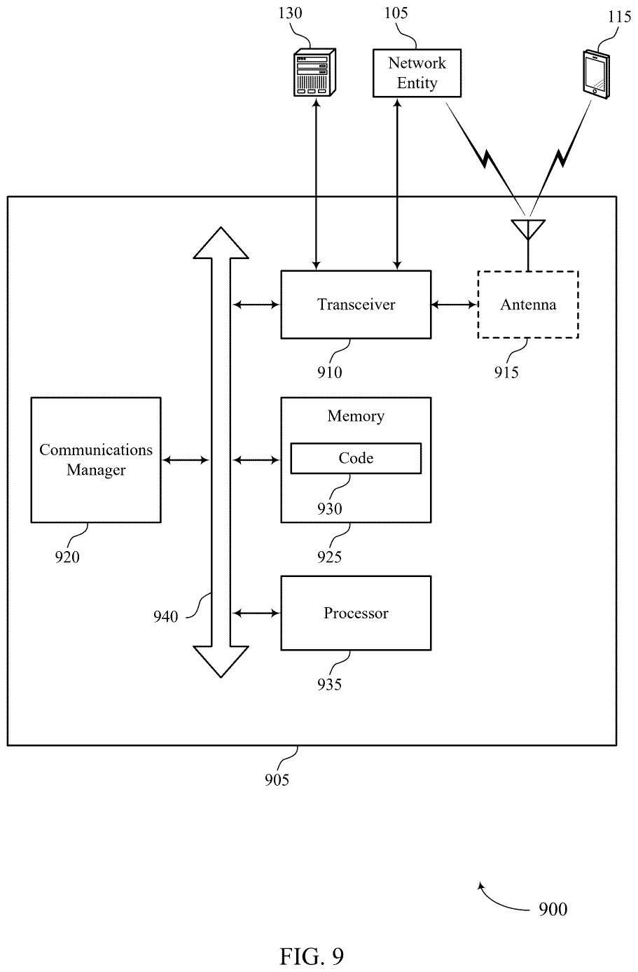

FIG. 9 shows a diagram of a system 900 including a device 905 that supports scheduling of XR perception-type traffic in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting scheduling of XR perception-type traffic). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for obtaining a message that is indicative of an uplink periodicity for XR perception-type traffic associated with a UE and that is indicative of an uplink-to-downlink offset for the XR perception-type traffic. The communications manager 920 is capable of, configured to, or operable to support a means for outputting, for the UE and based on the message, scheduling information for one or more downlink or uplink transmissions associated with the XR perception-type traffic.

By including or configuring the communications manager 920 in accordance with examples as described herein, the device 905 may support techniques for reduced power consumption, more efficient utilization of communication resources, improved coordination between devices, and longer battery life.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of scheduling of XR perception-type traffic as described herein, or the at least one processor 935 and the at least one memory 925 may be otherwise configured to, individually or collectively, perform or support such operations.

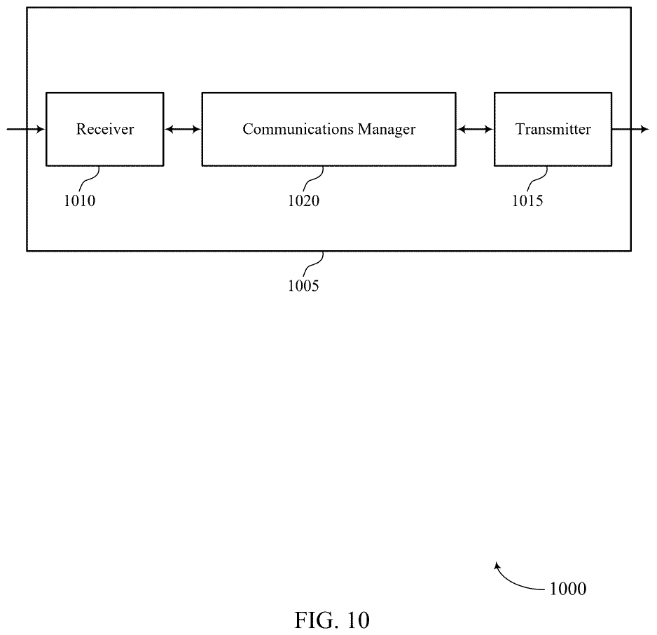

FIG. 10 shows a block diagram 1000 of a device 1005 that supports scheduling of XR perception-type traffic in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to scheduling of XR perception-type traffic). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to scheduling of XR perception-type traffic). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of scheduling of XR perception-type traffic as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting a message that is indicative of an uplink periodicity for XR perception-type traffic associated with the UE and that is indicative of an uplink-to-downlink offset for the XR perception-type traffic. The communications manager 1020 is capable of, configured to, or operable to support a means for receiving, based on the message, scheduling information for one or more downlink or uplink transmissions associated with the XR perception-type traffic.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced power consumption and more efficient utilization of communication resources.

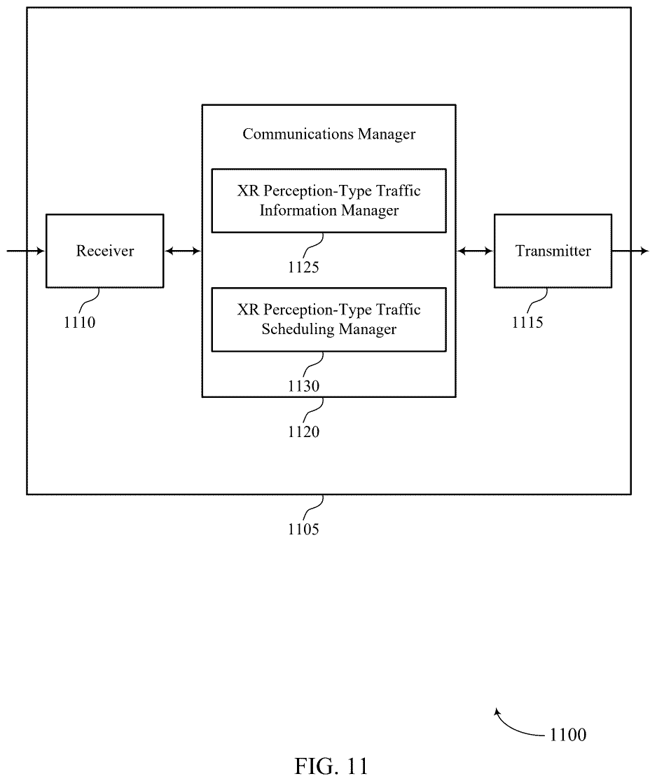

FIG. 11 shows a block diagram 1100 of a device 1105 that supports scheduling of XR perception-type traffic in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to scheduling of XR perception-type traffic). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to scheduling of XR perception-type traffic). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of scheduling of XR perception-type traffic as described herein. For example, the communications manager 1120 may include an XR perception-type traffic information manager 1125 an XR perception-type traffic scheduling manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The XR perception-type traffic information manager 1125 is capable of, configured to, or operable to support a means for transmitting a message that is indicative of an uplink periodicity for XR perception-type traffic associated with the UE and that is indicative of an uplink-to-downlink offset for the XR perception-type traffic. The XR perception-type traffic scheduling manager 1130 is capable of, configured to, or operable to support a means for receiving, based on the message, scheduling information for one or more downlink or uplink transmissions associated with the XR perception-type traffic.

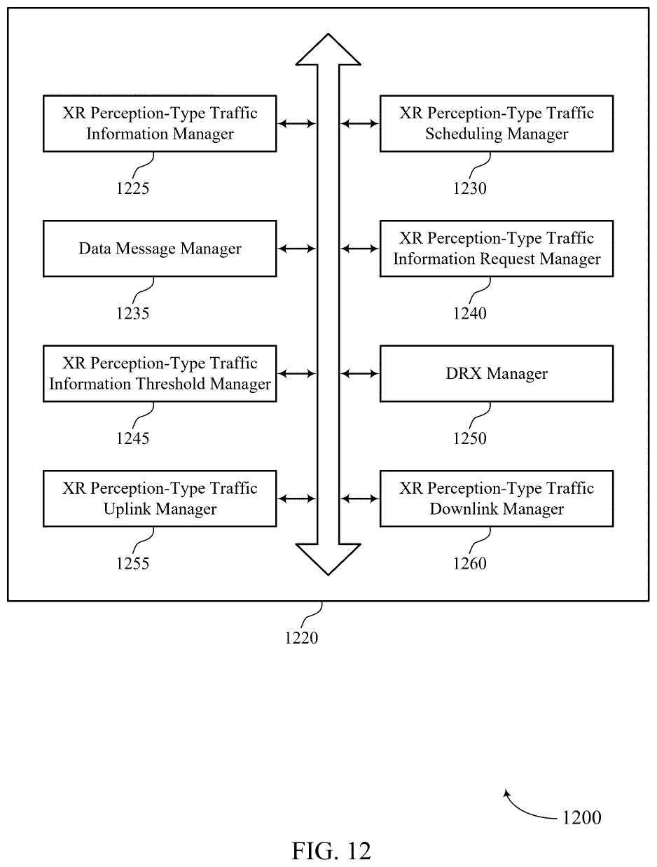

FIG. 12 shows a block diagram 1200 of a communications manager 1220 that supports scheduling of XR perception-type traffic in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of scheduling of XR perception-type traffic as described herein. For example, the communications manager 1220 may include an XR perception-type traffic information manager 1225, an XR perception-type traffic scheduling manager 1230, a data message manager 1235, an XR perception-type traffic information request manager 1240, an XR perception-type traffic information threshold manager 1245, a DRX manager 1250, an XR perception-type traffic uplink manager 1255, an XR perception-type traffic downlink manager 1260, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The XR perception-type traffic information manager 1225 is capable of, configured to, or operable to support a means for transmitting a message that is indicative of an uplink periodicity for XR perception-type traffic associated with the UE and that is indicative of an uplink-to-downlink offset for the XR perception-type traffic. The XR perception-type traffic scheduling manager 1230 is capable of, configured to, or operable to support a means for receiving, based on the message, scheduling information for one or more downlink or uplink transmissions associated with the XR perception-type traffic.

In some examples, the message is one of a RRC message, a MAC-CE, or an UCI message.

In some examples, to support transmitting the message, the data message manager 1235 is capable of, configured to, or operable to support a means for transmitting the message including a data packet and a header, where the header is indicative of the uplink periodicity and the uplink-to-downlink offset, where the data packet includes data associated with the XR perception-type traffic.

In some examples, the header includes a SDAP header or a PDCP header. In some examples, the data packet includes data associated with the XR perception-type traffic.

In some examples, the data message manager 1235 is capable of, configured to, or operable to support a means for transmitting a second message including a second data packet, where the second data packet includes data associated with the XR perception-type traffic, and where an indication of the uplink periodicity and the uplink-to-downlink offset is absent from the second message.

In some examples, the XR perception-type traffic information request manager 1240 is capable of, configured to, or operable to support a means for receiving a request for an indication of the uplink periodicity and the uplink-to-downlink offset, where transmitting the message is based on the request.

In some examples, the message is indicative of the uplink-to-downlink offset via inclusion of an indication of a delta value. In some examples, the delta value is with respect to a previous uplink-to-downlink offset.

In some examples, the indication of the delta value includes an index value from a table of delta values, the index value corresponding to the delta value.

In some examples, the XR perception-type traffic information threshold manager 1245 is capable of, configured to, or operable to support a means for receiving, where the message is a first message, a second message that indicates a threshold to trigger reporting of the uplink-to-downlink offset, where the first message indicates that the uplink-to-downlink offset is different from a previous value of the uplink-to-downlink offset by at least the threshold.

In some examples, to support receiving the scheduling information, the DRX manager 1250 is capable of, configured to, or operable to support a means for control signaling that configures a DRX for the UE.

In some examples, the message is indicative of the uplink-to-downlink offset via inclusion of an indication of a lower bound for the uplink-to-downlink offset and an upper bound for the uplink-to-downlink offset.

In some examples, the message is indicative of the uplink-to-downlink offset via inclusion of at least one of a range for the uplink-to-downlink offset, a mean for the uplink-to-downlink offset, or a standard deviation for the uplink-to-downlink offset.

In some examples, the XR perception-type traffic uplink manager 1255 is capable of, configured to, or operable to support a means for transmitting, in accordance with the uplink periodicity, an uplink transmission associated with the XR perception-type traffic. In some examples, the XR perception-type traffic downlink manager 1260 is capable of, configured to, or operable to support a means for receiving, in accordance with the scheduling information, a downlink transmission of the one or more downlink or uplink transmissions that is responsive to the uplink transmission.

In some examples, the XR perception-type traffic information manager 1225 is capable of, configured to, or operable to support a means for transmitting, via the message or a second message, an indication of a second uplink periodicity for a second type of XR perception-type traffic associated with the UE and an indication of a second uplink-to-downlink offset for the second type of XR perception-type traffic, where the XR perception-type traffic is a first type of XR perception-type traffic. In some examples, the XR perception-type traffic scheduling manager 1230 is capable of, configured to, or operable to support a means for receiving, based on the indication of the second uplink periodicity and the indication of the second uplink-to-downlink offset, second scheduling information for one or more second downlink or uplink transmissions associated with the second type of XR perception-type traffic.

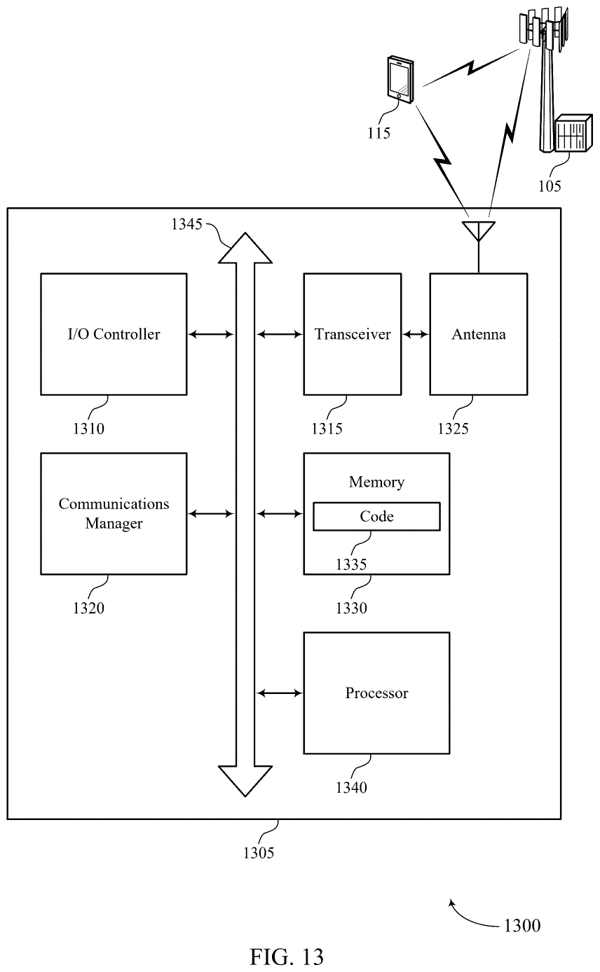

FIG. 13 shows a diagram of a system 1300 including a device 1305 that supports scheduling of XR perception-type traffic in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting scheduling of XR perception-type traffic). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for transmitting a message that is indicative of an uplink periodicity for XR perception-type traffic associated with the UE and that is indicative of an uplink-to-downlink offset for the XR perception-type traffic. The communications manager 1320 is capable of, configured to, or operable to support a means for receiving, based on the message, scheduling information for one or more downlink or uplink transmissions associated with the XR perception-type traffic.

By including or configuring the communications manager 1320 in accordance with examples as described herein, the device 1305 may support techniques for reduced power consumption, more efficient utilization of communication resources, improved coordination between devices, and longer battery life.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of scheduling of XR perception-type traffic as described herein, or the at least one processor 1340 and the at least one memory 1330 may be otherwise configured to, individually or collectively, perform or support such operations.

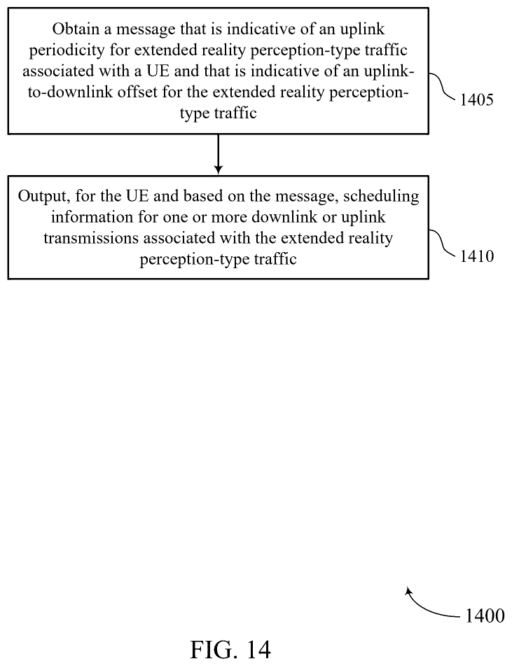

FIG. 14 shows a flowchart illustrating a method 1400 that supports scheduling of XR perception-type traffic in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include obtaining a message that is indicative of an uplink periodicity for XR perception-type traffic associated with a UE and that is indicative of an uplink-to-downlink offset for the XR perception-type traffic. The operations of 1405 may be performed in accordance with examples as disclosed herein. In some examples, aspects of the operations of 1405 may be performed by an XR perception-type traffic information manager 825 as described with reference to FIG. 8.

At 1410, the method may include outputting, for the UE and based on the message, scheduling information for one or more downlink or uplink transmissions associated with the XR perception-type traffic. The operations of 1410 may be performed in accordance with examples as disclosed herein. In some examples, aspects of the operations of 1410 may be performed by an XR perception-type traffic scheduling manager 830 as described with reference to FIG. 8.

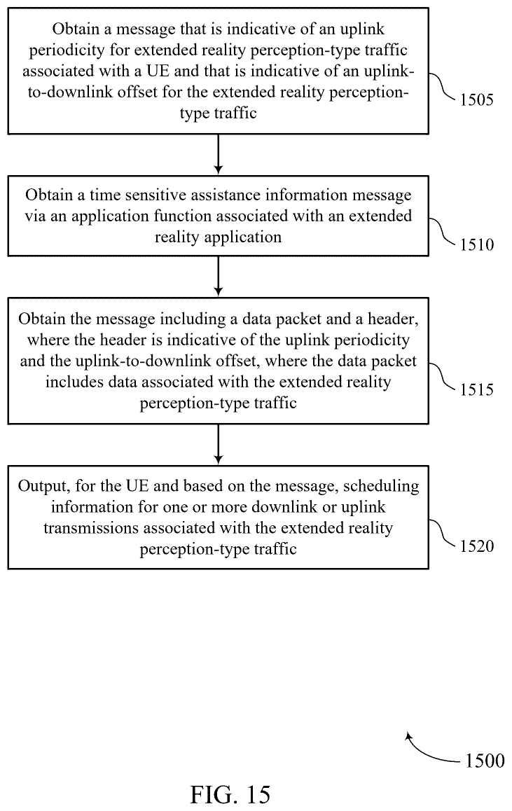

FIG. 15 shows a flowchart illustrating a method 1500 that supports scheduling of XR perception-type traffic in accordance with one or more aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include obtaining a message that is indicative of an uplink periodicity for XR perception-type traffic associated with a UE and that is indicative of an uplink-to-downlink offset for the XR perception-type traffic. The operations of 1505 may be performed in accordance with examples as disclosed herein. In some examples, aspects of the operations of 1505 may be performed by an XR perception-type traffic information manager 825 as described with reference to FIG. 8.

At 1510, the method may include obtaining a TSCAI message via an application function associated with an XR application. The operations of 1510 may be performed in accordance with examples as disclosed herein. In some examples, aspects of the operations of 1510 may be performed by a TSAIC manager 835 as described with reference to FIG. 8.

At 1515, the method may include obtaining the message including a data packet and a header, where the header is indicative of the uplink periodicity and the uplink-to-downlink offset, where the data packet includes data associated with the XR perception-type traffic. The operations of 1515 may be performed in accordance with examples as disclosed herein. In some examples, aspects of the operations of 1515 may be performed by a data message manager 840 as described with reference to FIG. 8.

At 1520, the method may include outputting, for the UE and based on the message, scheduling information for one or more downlink or uplink transmissions associated with the XR perception-type traffic. The operations of 1520 may be performed in accordance with examples as disclosed herein. In some examples, aspects of the operations of 1520 may be performed by an XR perception-type traffic scheduling manager 830 as described with reference to FIG. 8.

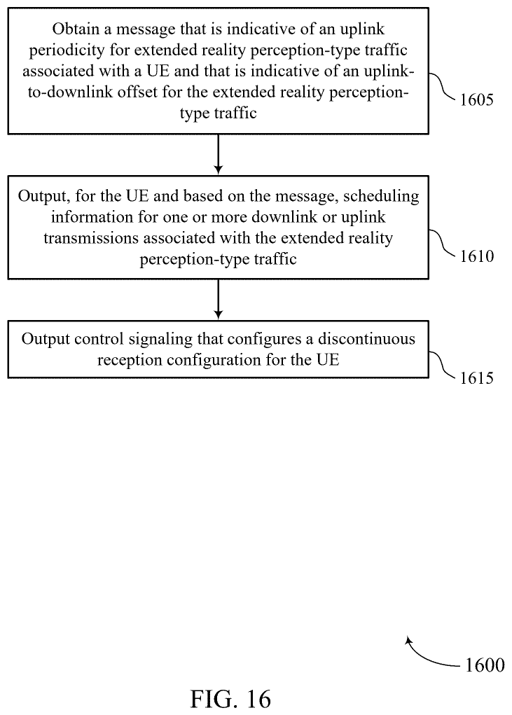

FIG. 16 shows a flowchart illustrating a method 1600 that supports scheduling of XR perception-type traffic in accordance with one or more aspects of the present disclosure. The operations of the method 1600 may be implemented by a network entity or its components as described herein. For example, the operations of the method 1600 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a message that is indicative of an uplink periodicity for XR perception-type traffic associated with a UE and that is indicative of an uplink-to-downlink offset for the XR perception-type traffic. The operations of 1605 may be performed in accordance with examples as disclosed herein. In some examples, aspects of the operations of 1605 may be performed by an XR perception-type traffic information manager 825 as described with reference to FIG. 8.

At 1610, the method may include outputting, for the UE and based on the message, scheduling information for one or more downlink or uplink transmissions associated with the XR perception-type traffic. The operations of 1610 may be performed in accordance with examples as disclosed herein. In some examples, aspects of the operations of 1610 may be performed by an XR perception-type traffic scheduling manager 830 as described with reference to FIG. 8.

At 1615, the method may include outputting control signaling that configures a DRX for the UE. The operations of 1615 may be performed in accordance with examples as disclosed herein. In some examples, aspects of the operations of 1615 may be performed by a DRX manager 855 as described with reference to FIG. 8.

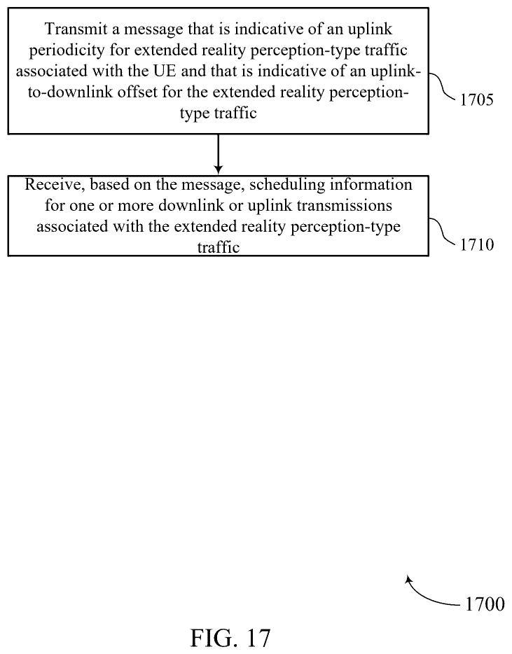

FIG. 17 shows a flowchart illustrating a method 1700 that supports scheduling of XR perception-type traffic in accordance with one or more aspects of the present disclosure. The operations of the method 1700 may be implemented by a UE or its components as described herein. For example, the operations of the method 1700 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1705, the method may include transmitting a message that is indicative of an uplink periodicity for XR perception-type traffic associated with the UE and that is indicative of an uplink-to-downlink offset for the XR perception-type traffic. The operations of 1705 may be performed in accordance with examples as disclosed herein. In some examples, aspects of the operations of 1705 may be performed by an XR perception-type traffic information manager 1225 as described with reference to FIG. 12.

At 1710, the method may include receiving, based on the message, scheduling information for one or more downlink or uplink transmissions associated with the XR perception-type traffic. The operations of 1710 may be performed in accordance with examples as disclosed herein. In some examples, aspects of the operations of 1710 may be performed by an XR perception-type traffic scheduling manager 1230 as described with reference to FIG. 12.

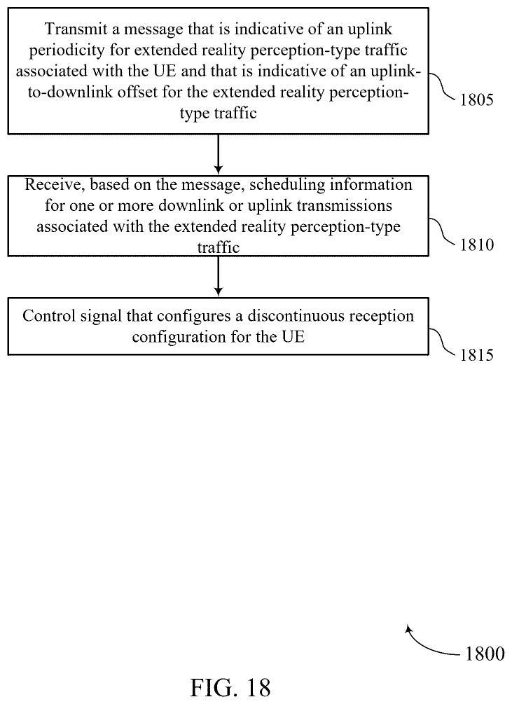

FIG. 18 shows a flowchart illustrating a method 1800 that supports scheduling of XR perception-type traffic in accordance with one or more aspects of the present disclosure. The operations of the method 1800 may be implemented by a UE or its components as described herein. For example, the operations of the method 1800 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1805, the method may include transmitting a message that is indicative of an uplink periodicity for XR perception-type traffic associated with the UE and that is indicative of an uplink-to-downlink offset for the XR perception-type traffic. The operations of 1805 may be performed in accordance with examples as disclosed herein. In some examples, aspects of the operations of 1805 may be performed by an XR perception-type traffic information manager 1225 as described with reference to FIG. 12.

At 1810, the method may include receiving, based on the message, scheduling information for one or more downlink or uplink transmissions associated with the XR perception-type traffic. The operations of 1810 may be performed in accordance with examples as disclosed herein. In some examples, aspects of the operations of 1810 may be performed by an XR perception-type traffic scheduling manager 1230 as described with reference to FIG. 12.

At 1815, the method may include control signaling that configures a DRX for the UE. The operations of 1815 may be performed in accordance with examples as disclosed herein. In some examples, aspects of the operations of 1815 may be performed by a DRX manager 1250 as described with reference to FIG. 12.

The following provides an overview of aspects of the present disclosure:

Aspect 1: A method for wireless communications at a network entity, comprising: obtaining a message that is indicative of an uplink periodicity for XR perception-type traffic associated with a UE and that is indicative of an uplink-to-downlink offset for the XR perception-type traffic; and outputting, for the UE and based at least in part on the message, scheduling information for one or more downlink or uplink transmissions associated with the XR perception-type traffic.

Aspect 2: The method of aspect 1, wherein obtaining the message comprises: obtaining a time sensitive assistance information (TSCAI) message via an application function associated with an XR application.

Aspect 3: The method of aspect 1, wherein obtaining the message comprises: obtaining the message comprising a data packet and a header, wherein the header is indicative of the uplink periodicity and the uplink-to-downlink offset, wherein the data packet comprises data associated with the XR perception-type traffic.

Aspect 4: The method of aspect 3, wherein obtaining the message comprises: obtaining the message via an application function associated with an XR application, wherein the header comprises an RTP header extension.

Aspect 5: The method of aspect 3, wherein obtaining the message comprises: obtaining the message via a user plane function, wherein the header comprises a general packet radio service tunnelling protocol header.

Aspect 6: The method of aspect 3, wherein obtaining the message comprises: obtaining the message via the UE, wherein the header comprises a SDAP header or a PDCP header, and wherein the data packet comprises data associated with the XR perception-type traffic.

Aspect 7: The method of any of aspects 3 through 6, further comprising: obtaining a second message comprising a second data packet, wherein the second data packet comprises data associated with the XR perception-type traffic, and wherein an indication of the uplink periodicity and the uplink-to-downlink offset is absent from the second message.

Aspect 8: The method of any of aspects 1 through 7, further comprising: outputting a request for an indication of the uplink periodicity and the uplink-to-downlink offset, wherein the message is based at least in part on the request.

Aspect 9: The method of any of aspects 1 or 8, wherein the message is one of an RRC message, a MAC-CE, or a UCI message.

Aspect 10: The method of any of aspects 1 or 3-8, further comprising: outputting, wherein the message obtained via the UE and is a first message, a second message for the UE that indicates a threshold to trigger reporting of the uplink-to-downlink offset, wherein the first message indicates that the uplink-to-downlink offset is different from a previous value of the uplink-to-downlink offset by at least the threshold.

Aspect 11: The method of any of aspects 1 through 10, wherein the message is indicative of the uplink-to-downlink offset via inclusion of an indication of a delta value, and the delta value is with respect to a previous uplink-to-downlink offset.

Aspect 12: The method of aspect 11, wherein the indication of the delta value comprises an index value from a table of delta values, the index value corresponding to the delta value.

Aspect 13: The method of any of aspects 1 through 12, wherein outputting the scheduling information comprises: outputting control signaling that configures a discontinuous reception configuration for the UE.

Aspect 14: The method of any of aspects 1 through 13, wherein the message is indicative of the uplink-to-downlink offset via inclusion of an indication of a lower bound for the uplink-to-downlink offset and an upper bound for the uplink-to-downlink offset.

Aspect 15: The method of any of aspects 1 through 14, wherein the message is indicative of the uplink-to-downlink offset via inclusion of at least one of a range for the uplink-to-downlink offset, a mean for the uplink-to-downlink offset, or a standard deviation for the uplink-to-downlink offset.

Aspect 16: The method of any of aspects 1 through 15, further comprising: obtaining, in association with the UE and in accordance with the uplink periodicity, an uplink transmission associated with the XR perception-type traffic; and outputting, for the UE and in accordance with the scheduling information, a downlink transmission of the one or more downlink or uplink transmissions that is responsive to the uplink transmission.

Aspect 17: The method of any of aspects 1 through 16, further comprising: outputting, to a target network entity for a handover procedure associated with the UE, a second message that indicates the XR perception-type traffic and the uplink-to-downlink offset for the XR perception-type traffic.

Aspect 18: The method of any of aspects 1 through 17, further comprising: obtaining, via the message or a second message, an indication of a second uplink periodicity for a second type of XR perception-type traffic associated with the UE and an indication of a second uplink-to-downlink offset for the second type of XR perception-type traffic, wherein the XR perception-type traffic is a first type of XR perception-type traffic; and outputting for the UE and based at least in part on the indication of the second uplink periodicity and the indication of the second uplink-to-downlink offset, second scheduling information for one or more second downlink or uplink transmissions associated with the second type of XR perception-type traffic.

Aspect 19: A method for wireless communications at a UE, comprising: transmitting a message that is indicative of an uplink periodicity for XR perception-type traffic associated with the UE and that is indicative of an uplink-to-downlink offset for the XR perception-type traffic; and receiving, based at least in part on the message, scheduling information for one or more downlink or uplink transmissions associated with the XR perception-type traffic.

Aspect 20: The method of aspect 19, wherein the message is one of an RRC message, a MAC-CE, or a UCI message.

Aspect 21: The method of aspect 19, wherein transmitting the message comprises: transmitting the message comprising a data packet and a header, wherein the header is indicative of the uplink periodicity and the uplink-to-downlink offset, wherein the data packet comprises data associated with the XR perception-type traffic.

Aspect 22: The method of aspect 21, wherein the header comprises a SDAP header or a packet data convergence protocol header, and the data packet comprises data associated with the XR perception-type traffic.

Aspect 23: The method of any of aspects 21 through 22, further comprising: transmitting a second message comprising a second data packet, wherein the second data packet comprises data associated with the XR perception-type traffic, and wherein an indication of the uplink periodicity and the uplink-to-downlink offset is absent from the second message.

Aspect 24: The method of any of aspects 19 through 23, further comprising: receiving a request for an indication of the uplink periodicity and the uplink-to-downlink offset, wherein transmitting the message is based at least in part on the request.

Aspect 25: The method of any of aspects 19 through 24, wherein the message is indicative of the uplink-to-downlink offset via inclusion of an indication of a delta value, and the delta value is with respect to a previous uplink-to-downlink offset.

Aspect 26: The method of aspect 25, wherein the indication of the delta value comprises an index value from a table of delta values, the index value corresponding to the delta value.

Aspect 27: The method of any of aspects 19 through 26, further comprising: receiving, wherein the message is a first message, a second message that indicates a threshold to trigger reporting of the uplink-to-downlink offset, wherein the first message indicates that the uplink-to-downlink offset is different from a previous value of the uplink-to-downlink offset by at least the threshold.

Aspect 28: The method of any of aspects 19 through 27, wherein receiving the scheduling information comprises: control signaling that configures a discontinuous reception configuration for the UE.

Aspect 29: The method of any of aspects 19 through 28, wherein the message is indicative of the uplink-to-downlink offset via inclusion of an indication of a lower bound for the uplink-to-downlink offset and an upper bound for the uplink-to-downlink offset.

Aspect 30: The method of any of aspects 19 through 29, wherein the message is indicative of the uplink-to-downlink offset via inclusion of at least one of a range for the uplink-to-downlink offset, a mean for the uplink-to-downlink offset, or a standard deviation for the uplink-to-downlink offset.

Aspect 31: The method of any of aspects 19 through 30, further comprising: transmitting, in accordance with the uplink periodicity, an uplink transmission associated with the XR perception-type traffic; and receiving, in accordance with the scheduling information, a downlink transmission of the one or more downlink or uplink transmissions that is responsive to the uplink transmission.

Aspect 32: The method of any of aspects 19 through 31, further comprising: transmitting, via the message or a second message, an indication of a second uplink periodicity for a second type of XR perception-type traffic associated with the UE and an indication of a second uplink-to-downlink offset for the second type of XR perception-type traffic, wherein the XR perception-type traffic is a first type of XR perception-type traffic; and receiving, based at least in part on the indication of the second uplink periodicity and the indication of the second uplink-to-downlink offset, second scheduling information for one or more second downlink or uplink transmissions associated with the second type of XR perception-type traffic.

Aspect 33: A network entity for wireless communications, comprising one or more memories storing processor-executable code, and one or more processors coupled with the one or more memories and individually or collectively operable to execute the code to cause the network entity to perform a method of any of aspects 1 through 18.

Aspect 34: A network entity for wireless communications, comprising at least one means for performing a method of any of aspects 1 through 18.

Aspect 35: A non-transitory computer-readable medium storing code for wireless communications, the code comprising instructions executable by one or more processors to perform a method of any of aspects 1 through 18.

Aspect 36: A UE for wireless communications, comprising one or more memories storing processor-executable code, and one or more processors coupled with the one or more memories and individually or collectively operable to execute the code to cause the UE to perform a method of any of aspects 19 through 32.

Aspect 37: A UE for wireless communications, comprising at least one means for performing a method of any of aspects 19 through 32.

Aspect 38: A non-transitory computer-readable medium storing code for wireless communications, the code comprising instructions executable by one or more processors to perform a method of any of aspects 19 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of′) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain a message that is indicative of an uplink periodicity for extended reality perception-type traffic associated with a user equipment (UE) and that is indicative of an uplink-to-downlink offset for the extended reality perception-type traffic; and
output, for the UE and based at least in part on the message, scheduling information for one or more downlink or uplink transmissions associated with the extended reality perception-type traffic.

2. The network entity of claim 1, wherein, to obtain the message,
the one or more processors are individually or collectively operable to execute the code to cause the network entity to:
obtain a time sensitive assistance information message via an application function associated with an extended reality application.

3. The network entity of claim 1, wherein, to obtain the message, the one or more processors are individually or collectively operable to execute the code to cause the network entity to:
obtain the message comprising a data packet and a header, wherein the header is indicative of the uplink periodicity and the uplink-to-downlink offset, wherein the data packet comprises data associated with the extended reality perception-type traffic.

4. The network entity of claim 3, wherein, to obtain the message, the one or more processors are individually or collectively operable to execute the code to cause the network entity to:
obtain the message via an application function associated with an extended reality application, wherein the header comprises a real time transfer protocol header extension.

5. The network entity of claim 3, wherein, to obtain the message, the one or more processors are individually or collectively operable to execute the code to cause the network entity to:
obtain the message via a user plane function, wherein the header comprises a general packet radio service tunnelling protocol header.

6. The network entity of claim 3, wherein, to obtain the message, the one or more processors are individually or collectively operable to execute the code to cause the network entity to:
obtain the message via the UE, wherein the header comprises a Service Data Adaption Protocol header or a packet data convergence protocol header, and wherein the data packet comprises data associated with the extended reality perception-type traffic.

7. The network entity of claim 3, wherein the one or more processors are individually or collectively further operable to execute the code to cause the network entity to:
obtain a second message comprising a second data packet, wherein the second data packet comprises data associated with the extended reality perception-type traffic, and wherein an indication of the uplink periodicity and the uplink-to-downlink offset is absent from the second message.

8. The network entity of claim 1, wherein the one or more processors are individually or collectively further operable to execute the code to cause the network entity to:
output a request for an indication of the uplink periodicity and the uplink-to-downlink offset, wherein the message is based at least in part on the request.

9. The network entity of claim 1, wherein the message is one of a radio resource control message, a medium access control (MAC) control element, or an uplink control information message.

10. The network entity of claim 1, wherein the one or more processors are individually or collectively further operable to execute the code to cause the network entity to:
output, wherein the message obtained via the UE and is a first message, a second message for the UE that indicates a threshold to trigger reporting of the uplink-to-downlink offset, wherein the first message indicates that the uplink-to-downlink offset is different from a previous value of the uplink-to-downlink offset by at least the threshold.

11. The network entity of claim 1, wherein:
the message is indicative of the uplink-to-downlink offset via inclusion of an indication of a delta value, and
the delta value is with respect to a previous uplink-to-downlink offset.

12. The network entity of claim 11, wherein the indication of the delta value comprises an index value from a table of delta values, the index value corresponding to the delta value.

13. The network entity of claim 1, wherein, to output the scheduling information, the one or more processors are individually or collectively operable to execute the code to cause the network entity to:
output control signaling that configures a discontinuous reception configuration for the UE.

14. The network entity of claim 1, wherein the message is indicative of the uplink-to-downlink offset via inclusion of an indication of a lower bound for the uplink-to-downlink offset and an upper bound for the uplink-to-downlink offset.

15. The network entity of claim 1, wherein the message is indicative of the uplink-to-downlink offset via inclusion of at least one of a range for the uplink-to-downlink offset, a mean for the uplink-to-downlink offset, or a standard deviation for the uplink-to-downlink offset.

16. The network entity of claim 1, wherein the one or more processors are individually or collectively further operable to execute the code to cause the network entity to:
obtain, in association with the UE and in accordance with the uplink periodicity, an uplink transmission associated with the extended reality perception-type traffic; and
output, for the UE and in accordance with the scheduling information, a downlink transmission of the one or more downlink or uplink transmissions that is responsive to the uplink transmission.

17. The network entity of claim 1, wherein the one or more processors are individually or collectively further operable to execute the code to cause the network entity to:
output, to a target network entity for a handover procedure associated with the UE, a second message that indicates the extended reality perception-type traffic and the uplink-to-downlink offset for the extended reality perception-type traffic.

18. The network entity of claim 1, wherein the one or more processors are individually or collectively further operable to execute the code to cause the network entity to:
obtain, via the message or a second message, an indication of a second uplink periodicity for a second type of extended reality perception-type traffic associated with the UE and an indication of a second uplink-to-downlink offset for the second type of extended reality perception-type traffic, wherein the extended reality perception-type traffic is a first type of extended reality perception-type traffic; and
output for the UE and based at least in part on the indication of the second uplink periodicity and the indication of the second uplink-to-downlink offset, second scheduling information for one or more second downlink or uplink transmissions associated with the second type of extended reality perception-type traffic.

19. A method for wireless communications at a network entity, comprising:
obtaining a message that is indicative of an uplink periodicity for extended reality perception-type traffic associated with a user equipment (UE) and that is indicative of an uplink-to-downlink offset for the extended reality perception-type traffic; and
outputting, for the UE and based at least in part on the message, scheduling information for one or more downlink or uplink transmissions associated with the extended reality perception-type traffic.

20. A non-transitory computer-readable medium storing code for wireless communications at a network entity, the code comprising instructions executable by one or more processors to:
obtain a message that is indicative of an uplink periodicity for extended reality perception-type traffic associated with a user equipment (UE) and that is indicative of an uplink-to-downlink offset for the extended reality perception-type traffic; and
output, for the UE and based at least in part on the message, scheduling information for one or more downlink or uplink transmissions associated with the extended reality perception-type traffic.
